(19) United States
(12) Patent Application Publication
(10) Pub. No.: US 2014/0307299 A1
(43) Pub. Date: Oct. 16, 2014

(54) LIGHT MODULATION CONTROL METHOD, CONTROL PROGRAM, CONTROL DEVICE AND LASER BEAM IRRADIATION DEVICE

(71) Applicant: HAMAMATSU PHOTONICS K.K., Hamamatsu-shi, Shizuoka (JP)

(72) Inventors: Naoya Matsumoto, Hamamatsu-shi (JP); Yuu Takiguchi, Hamamatsu-shi (JP); Taro Ando, Hamamatsu-shi (JP); Yoshiyuki Ohtake, Hamamatsu-shi (JP); Takashi Inoue, Hamamatsu-shi (JP); Tomoko Otsu, Hamamatsu-shi (JP); Haruyoshi Toyoda, Hamamatsu-shi (JP)

(73) Assignee: HAMAMATSU PHOTONICS K.K., Hamamatsu-shi, Sihzuoka (JP)

(21) Appl. No.: 14/353,834

(22) PCT Filed: Oct. 23, 2012
(86) PCT No.: PCT/JP2012/077355

§ 371 Date: Apr. 24, 2014

(30) Foreign Application Priority Data
Oct. 26, 2011 (JP) 2011-235236

(51) Int. Cl. G02F 1/01

(52) U.S. Cl. CPC G02F 1/0121
USPC 359/238

(57) ABSTRACT

In the control of light condensing irradiation of laser light using a spatial light modulator, the number of wavelengths, a value of each wavelength, and incident conditions of the laser light are acquired, the number of light condensing points, and a light condensing position, a wavelength, and a light condensing intensity on each light condensing point are set, and a light condensing control pattern is set for each light condensing point. Then, a modulation pattern presented in the spatial light modulator is designed in consideration of the light condensing control pattern. Further, in the design of a modulation pattern, a design method focusing on an effect by a phase value of one pixel is used, and when evaluating a light condensing state, a propagation function to which a phase pattern opposite to the light condensing control pattern is added is used.

### TECHNICAL FIELD

The present invention relates to a light modulation control method, a control program, and a control device which control light condensing irradiation of laser light onto a light condensing point by a modulation pattern to be presented in a spatial light modulator, and a laser light irradiation device using the same.

### BACKGROUND ART

Laser light irradiation devices which irradiate an object with laser light under predetermined light condensing conditions have been used as various optical devices such as a laser processing device, a laser microscope for observing scattering and reflection of laser light. Further, in such a laser light irradiation device, there is a configuration in which light condensing irradiation conditions of laser light for an object are set and controlled by use of a phase-modulation type spatial light modulator (SLM: Spatial Light Modulator).

In a laser light irradiation device using a spatial light modulator, for example, a hologram (CGH: Computer Generated Hologram) set by a numerical calculation is presented in the modulator, thereby it is possible to control the light condensing irradiation conditions such as a light condensing position, a light condensing intensity, and a light condensing shape of laser light on an irradiation object (refer to, for example, Patent Documents 1 to 4, Non-Patent Documents 1 to 6).

### CITATION LIST

### Patent Literature

Patent Document 1: Japanese Patent Application Laid-Open No. 2010-58128
Patent Document 2: Japanese Patent Application Laid-Open No. 2010-75997
Patent Document 3: Japanese Patent Publication No. 4300101
Patent Document 4: Japanese Patent Application Laid-Open No. 2005-84266

### Non Patent Literature

Non-Patent Document 1: J. Bengtsson, “Kinoforms designed to produce different fan-out patterns for two wavelengths,” Appl. Opt. Vol. 37 No. 11 (1998) pp. 2011-2020
Non-Patent Document 2: Y. Ogura et al., “Wavelength-multiplexing diffractive phase elements: design, fabrication, and performance evaluation,” J. Opt. Soc. Am. A Vol. 18 No. 5 (2001) pp. 1082-1092
Non-Patent Document 3: N. Yoshikawa et al., “Phase optimization of a kinoform by simulated annealing,” Appl. Opt. Vol. 33 No. 5 (1994) pp. 863-868
Non-Patent Document 4: N. Yoshikawa et at, “Quantized phase optimization of two-dimensional Fourier kinoforms by a genetic algorithm,” Opt. Lett. Vol. 20 No. 7 (1995) pp. 752-754
Non-Patent Document 5: J. Leach et al., “Observation of chromatic effects near a white-light vortex,” New Journal of Physics Vol. 5 (2003) pp. 154.1-154.7
Non-Patent Document 6: T. Ando et al., “Mode purities of Laguerre-Gaussian beams generated via complex-amplitude modulation using phase-only spatial light modulators,” Opt. Lett. Vol. 34 No. 1 (2009) pp. 34-36
Non-Patent Document 7: S. W. Hell et al., “Breaking the diffraction resolution limit by stimulated emission: stimulated-emission-depletion fluorescence microscopy,” Opt. Lett. Vol. 19 No. 11 (1994) pp. 780-782
Non-Patent Document 8: D. Wildanger et al., “A STED microscope aligned by design,” Opt. Express Vol. 17 No. 18 (2009) pp. 16100-16110

### SUMMARY OF INVENTION

### Technical Problem

As described above, in light condensing irradiation of laser light utilizing a phase-modulation type spatial light modulator, it is possible to irradiate an arbitrary light condensing position with laser light in an arbitrary light condensing shape by a phase pattern to be presented in the spatial light modulator. For example, in the case where an attempt is made to irradiate a predetermined position with laser light in a ring-shaped light condensing shape, a phase pattern

φ_{SLM}=φ_{CGH}+φₚₐₜ

that is, a phase pattern φ_{CGH} of a CGH which is designed so as to provide a phase distribution which condenses laser light on a predetermined position and a light condensing control pattern φₚₐₜ for condensing the laser light into a ring shape are added, is to be presented in the spatial light modulator, light condensing irradiation of the laser light is thereby achieved.

However, in such a method, in some cases, it is not possible to obtain a sufficient degree of freedom of control of a light condensing state of laser light. As such an example, in the case where light condensing irradiation of laser light containing light components of plural wavelengths is performed on an object by a single spatial light modulator, in the above-described method, because the same light condensing control pattern acts on the laser light components of the respective wavelengths, for example, it is not possible to achieve light condensing conditions such as setting a light condensing shape of laser light to a different shape at each wavelength and the like.

Further, in the above-described configuration, because the phase pattern acting on laser light is changed in phase difference provided for the laser light at a different wavelength, a phase pattern changed from the desired light condensing control pattern is to be provided at each wavelength. Such a problem of a degree of freedom in light condensing control is caused in the same way in a configuration other than the light condensing irradiation of laser light at plural wavelengths.

The present invention has been achieved in order to solve the above-described problem, and an object thereof is to provide a light modulation control method, a light modulation control program, and a light modulation control device by which it is possible to preferably achieve light condensing control of the laser light at a sufficient degree of freedom, and a laser light irradiation device using the same.

### Solution to Problem

In order to achieve such an object, a light modulation control method according to the present invention (1) which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the method includes (2) an irradiation condition acquiring step of acquiring the number of wavelengths xₜ (xₜ is an integer of 1 or more) of the laser light to be input to the spatial light modulator, xₜ wavelengths λₓ (x=1, . . . , and xₜ), and incident conditions of the laser light at each wavelength λₓ to the spatial light modulator, as irradiation conditions of the laser light, (3) a light condensing condition setting step of setting the number of the light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s (s=1, . . . , and sₜ), as light condensing conditions of the laser light, (4) a control pattern setting step of setting a light condensing control pattern for controlling a light condensing state as a phase pattern to be provided for the laser light at the wavelength λₓ for each of the sₜ light condensing points s, and (5) a modulation pattern designing step of designing the modulation pattern to be presented in the spatial light modulator in consideration of the light condensing control pattern set in the control pattern setting step, and in the method, (6) the modulation pattern designing step assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and when evaluating the light condensing state on the light condensing point, a propagation function φ_{js,x}′

φ_{js,x}′=φ_{js,x}−φ_{js-pat,x}

that is, a phase pattern opposite to the light condensing control pattern φ_{js-pat,x} which is set in the control pattern setting step is added to a wave propagation function φ_{js,x} is used, for propagation of light at a wavelength λₓ from a pixel j in the modulation pattern of the spatial light modulator to the light condensing point s.

Further, a light modulation control program according to the present invention (1) which is for causing a computer to execute light modulation control that controls light condensing irradiation of the laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the program causes the computer to execute (2) irradiation condition acquiring processing of acquiring the number of wavelengths xₜ (xₜ is an integer of 1 or more) of the laser light to be input to the spatial light modulator, xₜ wavelengths λₓ (x=1, . . . , and xₜ), and incident conditions of the laser light at each wavelength λₓ to the spatial light modulator, as irradiation conditions of the laser light, (3) light condensing condition setting processing of setting the number of light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s (s=1, . . . , and sₜ), as light condensing conditions of the laser light, (4) control pattern setting processing of setting a light condensing control pattern for controlling a light condensing state as a phase pattern to be provided for the laser light at the wavelength λₓ for each of the sₜ light condensing points s, and (5) modulation pattern designing processing of designing the modulation pattern to be presented in the spatial light modulator in consideration of the light condensing control pattern set in the control pattern setting processing, and in the program, (6) the modulation pattern designing processing assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and when evaluating the light condensing state on the light condensing point, a propagation function φ_{js,x}′

φ_{js,x}′φ_{js,x}−φ_{js-pat,x}

that is, a phase pattern opposite to the light condensing control pattern φ_{js-pat,x} which is set in the control pattern setting processing is added to a wave propagation function φ_{js,x} is used, for propagation of light at a wavelength λₓ from a pixel j in the modulation pattern of the spatial light modulator to the light condensing point s.

Further, a light modulation control device according to the present invention (1) which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the device includes (2) irradiation condition acquiring means acquiring the number of wavelengths xₜ (xₜ is an integer of 1 or more) of the laser light to be input to the spatial light modulator, xₜ wavelengths λₓ (x=1, . . . , and xₜ), and incident conditions of the laser light at each wavelength λₓ to the spatial light modulator, as irradiation conditions of the laser light, (3) light condensing condition setting means setting the number of light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s (s=1, . . . , and sₜ), as light condensing conditions of the laser light, (4) control pattern setting means setting a light condensing control pattern for controlling a light condensing state as a phase pattern to be provided for the laser light at the wavelength λₓ for each of the sₜ light condensing points s, and (5) modulation pattern designing means designing the modulation pattern to be presented in the spatial light modulator in consideration of the light condensing control pattern set in the control pattern setting means, and in the device, (6) the modulation pattern designing means assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and when evaluating the light condensing state on the light condensing point, a propagation function φ_{js,x}′

φ_{js,x}′=φ_{js,x}−φ_{js-pat,x}

that is, a phase pattern opposite to the light condensing control pattern φ_{js-pat,x} which is set in the control pattern setting means is added to a wave propagation function φ_{js,x} is used, for propagation of light at a wavelength λₓ from a pixel j in the modulation pattern of the spatial light modulator to the light condensing point s.

In the above-described light modulation control method, control program, and control device, for light condensing irradiation with the laser light onto the light condensing point by use of a spatial light modulator, the information on the number of wavelengths xₜ of the laser light, a value of a wavelength λₓ, and incident conditions (for example, an incident amplitude, an incident phase) of the laser light at each wavelength λₓ to the spatial light modulator is acquired, and the light condensing conditions including the number of light condensing points sₜ of the laser light, and a light condensing position, a wavelength λₓ of the laser light to be condensed, and a light condensing intensity on each light condensing point s are set. Then, a phase pattern for light condensing control to be provided for the laser light at the wavelength λₓ is set for each light condensing point s, and a modulation pattern is designed in consideration of the light condensing control patterns. Thereby, it is possible to preferably control the light condensing irradiation conditions of the laser light at the wavelength λₓ condensed on each light condensing point s.

Moreover, for the design of a modulation pattern, specifically, a pixel structure of a plurality of pixels is assumed in the spatial light modulator. Then, a design method focusing on an effect on a light condensing state of the laser light on the light condensing point s by changing the phase value of one pixel in the modulation pattern is used, and in an evaluation of the light condensing state of the laser light at the wavelength λₓ, a propagation function φ_{js,x} from a pixel j in the spatial light modulator to the light condensing point s is not used directly, but a propagation function φ_{js,x}′ that a phase pattern opposite to the light condensing control pattern φ_{js-pat,x} is added is used, so as to evaluate the light condensing state.

In accordance with such a configuration, it is possible to reliably reflect the light condensing control pattern set for each light condensing point s and wavelength λₓ into a modulation pattern to be finally obtained, which makes it possible to preferably achieve light condensing control of the laser light at a sufficient degree of freedom. In addition, in the case where a spatial light modulator having a plurality of two-dimensionally arrayed pixels is used as the spatial light modulator, the pixel structure thereof may directly be applied to the design of a modulation pattern.

A laser light irradiation device according to the present invention includes (a) a laser light source which supplies laser light with xₜ (xₜ is an integer of 1 or more) wavelengths λₓ, (b) a phase-modulation type spatial light modulator which inputs the laser light thereto, to modulate a phase of the laser light, and which outputs the phase-modulated laser light, and (c) the light modulation control device having the above-described configuration which controls light condensing irradiation of the laser light at each wavelength λₓ onto set sₜ (sₜ is an integer of 1 or more) light condensing points s by a modulation pattern to be presented in the spatial light modulator.

In accordance with such a configuration, the light condensing control pattern which is set for each light condensing point s and wavelength λₓ is reliably reflected into a modulation pattern to be finally obtained by the light modulation control device, thereby it is possible to preferably achieve light condensing control of the laser light at a sufficient degree of freedom, which makes it possible to preferably achieve light condensing irradiation of the laser light on the light condensing point s set on an irradiation object, and operations such as processing, observations, and the like of the object thereby. Such a laser light irradiation device may be used as, for example, a laser processing device, a laser microscope, or the like. In addition, as a spatial light modulator, a spatial light modulator which has a plurality of two-dimensionally arrayed pixels, and which is configured to modulate a phase of laser light for each of the plurality of pixels is preferably used.

### Advantageous Effects of Invention

In accordance with the light modulation control method, the control program, the control device, and the laser light irradiation device using the same of the present invention, for light condensing irradiation with laser light onto a light condensing point by use of a spatial light modulator, the number of wavelengths of the laser light, a value of a wavelength, and incident conditions of the laser light to the spatial light modulator at each wavelength are acquired, the number of the light condensing points of the laser light, and a light condensing position, a wavelength of the laser light to be condensed, and a light condensing intensity on each light condensing point are set, a light condensing control pattern to be provided for the laser light at the wavelength to be condensed is set for each light condensing point, and a modulation pattern is designed in consideration of the light condensing control pattern, and in the design of a modulation pattern, a design method focusing on an effect on a light condensing state of the laser light on the light condensing point by changing the phase value of one pixel in the modulation pattern is used, and in an evaluation of the light condensing state of the laser light, a wave propagation function to which a phase pattern opposite to the light condensing control pattern is added is used, thereby it is possible to preferably achieve light condensing control of the laser light at a sufficient degree of freedom.

### BRIEF DESCRIPTION OF DRAWINGS

FIG. 1 is a diagram showing a configuration of an embodiment of a laser light irradiation device.

FIG. 2 is a block diagram showing an example of a configuration of a light modulation control device.

FIG. 3 is a flowchart showing an example of a light modulation control method.

FIG. 4 is a flowchart showing an example of a modulation pattern design method.

FIG. 5 is a diagram showing a configuration of a laser light irradiation device used for a confirmatory experiment.

FIG. 6 is a view showing an example of a light condensing control pattern in a spatial light modulator.

FIG. 7 is a view showing an example of light condensing control of laser light by the laser light irradiation device.

FIG. 8 is a flowchart showing another example of a modulation pattern design method.

### DESCRIPTION OF EMBODIMENTS

Hereinafter, an embodiment of a light modulation control method, a control program, a control device, and a laser light irradiation device according to the present invention will be described in detail with reference to the accompanying drawings. In addition, in the description of the drawings, the same components are denoted by the same reference symbols, and overlapping descriptions thereof will be omitted. Further, the dimensional ratios in the drawings are not necessarily equal to those in the descriptions.

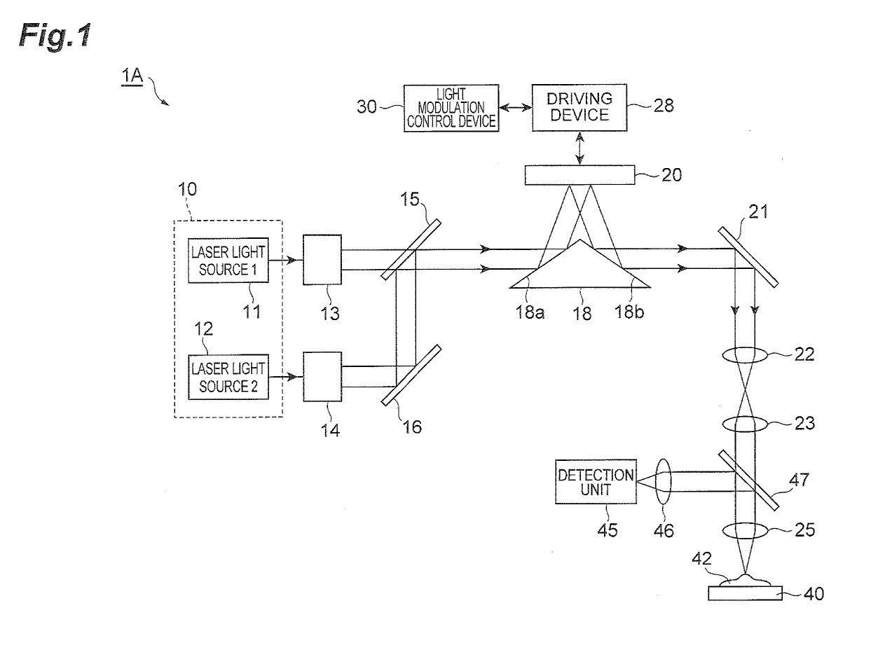

First, a basic configuration of a laser light irradiation device including a spatial light modulator, which serves as an object for light modulation control, will be described along with its configuration example. FIG. 1 is a diagram showing a configuration of an embodiment of the laser light irradiation device including a light modulation control device. A laser light irradiation device 1A according to the present embodiment is a device performing light condensing irradiation on an irradiation object 42 with laser light, and includes a laser light source unit 10, a spatial light modulator 20, and a movable stage 40.

In the configuration shown in FIG. 1, the irradiation object 42 is placed on the movable stage 40 which is configured to be movable in an X direction, a Y direction (horizontal direction), and a Z direction (vertical direction). Further, in the device 1A, a light condensing point for carrying out observations, processing, and the like for the irradiation object 42 is set to a predetermined position, and light condensing irradiation is performed on the light condensing point with laser light.

The laser light source unit 10 functions as a laser light source which supplies laser light with xₜ (xₜ is an integer of 1 or more) wavelengths λₓ (λₓ=λ₁, . . . , and λₓₜ). In the present embodiment, the number of wavelengths of the laser light is set to xₜ=2. Further, in response to this number of wavelengths, the laser light source unit 10 is composed of a first laser light source 11 which supplies laser light at a wavelength λ₁ and a second laser light source 12 which supplies laser light at a wavelength λ₂.

The laser light at a wavelength λ₁ from the laser light source 11 is expanded by a beam expander 13, to thereafter pass through a dichroic mirror 15. Further, the laser light at a wavelength λ₂ from the laser light source 12 is expanded by a beam expander 14, to be reflected by a mirror 16, and is thereafter reflected by the dichroic mirror 15. Thereby, the light beams from the laser light sources 11 and 12 are multiplexed in the dichroic mirror 15, to be laser light containing the wavelength components of the wavelengths λ₁ and λ₂. The laser light from the dichroic mirror 15 is input to the spatial light modulator (SLM) 20 via a first reflective surface 18a of a prism 18.

The spatial light modulator 20 is a phase-modulation type spatial light modulator, and, for example, modulates a phase of laser light at each portion on its two-dimensional modulation surface, to output a phase-modulated laser light. Here, given that a phase of laser light to be input to the spatial light modulator 20 is φᵢₙ, and a phase value to be provided in the spatial light modulator 20 is φ_{SLM}, a phase φₒᵤₜ of the laser light to be output is as follows.

φₒᵤₜφ_{SLM}+φᵢₙ

As the spatial light modulator 20, preferably, a spatial light modulator having a plurality of two-dimensionally arrayed pixels, that modulates a phase of the laser light at each of the plurality of pixels is used. In such a configuration, a modulation pattern such as a CGH is to be presented in the spatial light modulator 20, and light condensing irradiation of the laser light onto a set light condensing point is controlled by this modulation pattern. Further, the spatial light modulator 20 is drive-controlled by a light modulation control device 30 via a light modulator driving device 28. The specific configuration of the light modulation control device 30 will be described later. Further, as the spatial light modulator 20, a spatial light modulator without the above-described pixel structure may be used.

The spatial light modulator 20 may be a reflective type, or a transmissive type. In FIG. 1, a reflective type is shown as the spatial light modulator 20. Further, as the spatial light modulator 20, a refractive-index changing material type SLM (for example, as an SLM using a liquid crystal, an LCOS (Liquid Crystal on Silicon) type, an LCD (Liquid Crystal Display)), a Segment Mirror type SLM, a Continuous Deformable Mirror type SLM, or a DOE (Diffractive Optical Element), or the like is exemplified. In addition, as a DOE, a DOE whose phase is discretely expressed, or a DOE that a pattern is designed by use of a method which will be described later, to convert it into a continuous pattern by smoothing or the like is included.

A CGH designed as a modulation pattern is, for example, expressed in a DOE by use of electron beam exposure and etching, or its phase pattern is converted into a voltage distribution to be displayed on an SLM having a pixel structure, according to a configuration of the spatial light modulator 20. Further, in the case where laser light at plural wavelengths is modulated by a single SLM, a DOE available as a fixed pattern has mainly been used in a conventional example.

The laser light containing the wavelength components of the wavelengths λ₁ and λ₂, which is phase-modulated into a predetermined pattern in the spatial light modulator 20, to be output, is reflected by a second reflective surface 18b of the prism 18, and is propagated to an objective lens 25 composed of a single lens or a plurality of lenses by a mirror 21 and a 4f optical system composed of lenses 22 and 23. Then, with this objective lens 25, light condensing irradiation of the laser light is performed on a single or a plurality of light condensing points set on the surface or the inside of the irradiation object 42 on the stage 40.

Further, the laser light irradiation device 1A according to the present embodiment further includes a detection unit 45, a lens 46, and a dichroic mirror 47 in addition to the above-described configuration. The dichroic mirror 47 is provided between the lens 23 composing the 4f optical system and the objective lens 25 in the laser light irradiation optical system. Further, it is configured such that light from the irradiation object 42 reflected by the dichroic mirror 47 is to be incident to the detection unit 45 via the lens 46.

In accordance with this, the laser light irradiation device 1A of FIG. 1 is configured as a laser scanning microscope which irradiates an observation sample which is the irradiation object 42 with laser light, and makes observations for a reflected light, a scattering light, fluorescence, or the like from the sample with the detection unit 45. In addition, with respect to laser scanning of a sample, it is configured to move the irradiation object 42 by the movable stage 40 in FIG. 1, however, for example, it may also be configured such that this stage is fixed, and a movable mechanism, a galvano mirror, or the like may be provided on the optical system side. Further, as the laser light sources 11 and 12, pulsed laser light sources such as femtosecond laser light sources, which supply a pulsed laser light are preferably used. Further, as the laser light sources 11 and 12, CW (Continuous Wave) laser light sources may be used.

Further, the configuration of the optical system in the laser light irradiation device 1A is not specifically limited to the configuration shown in FIG. 1, and various configurations may be used. For example, in FIG. 1, the optical system is configured to expand laser light with the beam expanders 13 and 14, however, the optical system may also be configured to use a combination of a spatial filter and a collimator lens. Further, the driving device 28 may also be integrally provided with the spatial light modulator 20. Further, as the 4f optical system by the lenses 22 and 23, in general, a both-side telecentric optical system composed of a plurality of lenses is preferably used.

Further, for the laser light source unit 10 used for supplying laser light, the configuration by the laser light sources 11 and 12 which respectively output the laser light beams at the wavelengths λ₁ and λ₂ is exemplified, however, as a configuration of a laser light source, specifically, various configurations may be used. For example, the number of wavelengths xₜ of laser light may be set to 3 or more. Further, laser light may be set to have a single wavelength (xₜ=1), and a single laser light source may be used.

Further, in the present embodiment, the configuration of the laser scanning microscope used for cell observation or the like is exemplified, however, this laser light irradiation device may be applicable to, not only a laser microscope such as a laser scanning microscope, but also various devices such as a laser processing device which performs laser processing on the inside of the object 42 by light condensing irradiation on the irradiation object 42 with laser light. Further, in the case where the object 42 is processed by light condensing irradiation of laser light, examples thereof include preparation of an optical integrated circuit by an internal processing of glass or the like, however, a material of the object 42 is not limited to a glass medium, for example, various materials such as a silicon inside, SiC, and the like may serve as objects to be processed. In the above-described configuration, it is possible to achieve laser processing at a single wavelength, simultaneous laser processing at plural wavelengths, or the like.

In the laser light irradiation device 1A shown in FIG. 1, the configuration in which light condensing irradiation is performed on the object 42 with the laser light containing light components of the two wavelengths λ₁ and λ₂ via the single spatial light modulator 20 is exemplified. In such a configuration, in a conventional light modulation control method, because the same light condensing control pattern to be presented in the spatial light modulator 20 acts on the respective wavelength components of the laser light, in some cases, it is not possible to obtain a sufficient degree of freedom of light condensing control such as it is not possible to set a light condensing shape of the laser light to a different shape at each wavelength, for example. Further, in some cases, such a problem of the degree of freedom of light condensing control may be caused in a configuration other than that of light condensing irradiation of the laser light at the plural wavelengths.

In response to this, the laser light irradiation device 1A of FIG. 1 appropriately sets a CGH of a modulation pattern to be presented in the spatial light modulator 20 via the driving device 28 in the light modulation control device 30, thereby increasing the degree of freedom of light condensing control, to preferably control the light condensing irradiation conditions of the laser light on a light condensing point. Further, in accordance with the laser light irradiation device 1A and the light modulation control device 30 according to the present embodiment, as will be described later, even in the case where light condensing irradiation of laser light at plural wavelengths is performed, it is possible to preferably achieve control of the light condensing irradiation conditions of the laser light at each wavelength.

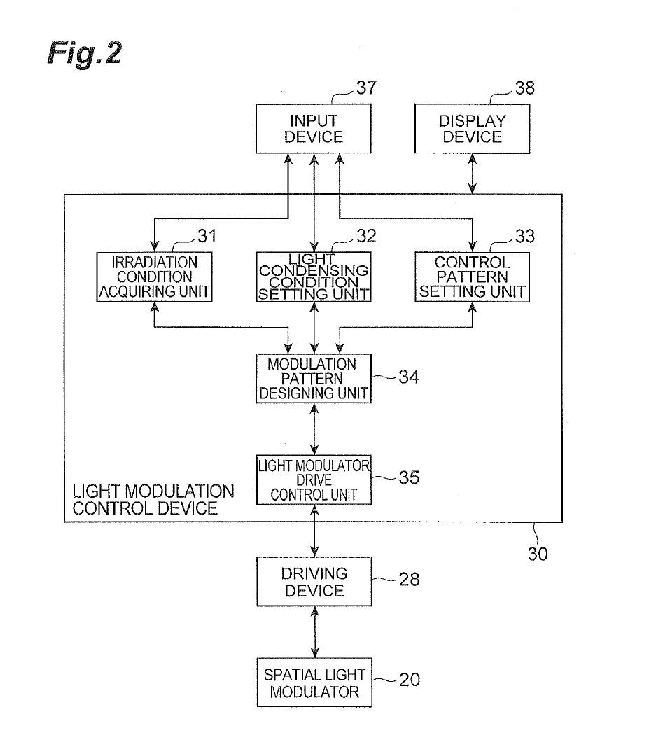

FIG. 2 is a block diagram showing an example of a configuration of the light modulation control device 30 which is applied to the laser light irradiation device 1A shown in FIG. 1. The light modulation control device 30 according to the present configuration example includes an irradiation condition acquiring unit 31, a light condensing condition setting unit 32, a light condensing control pattern setting unit 33, a modulation pattern designing unit 34, and a light modulator drive control unit 35. In addition, such a light modulation control device 30 may be composed of, for example, a computer. Further, an input device 37 used for inputting information, instructions, and the like necessary for light modulation control, and a display device 38 used for displaying information for an operator are connected to this control device 30.

The irradiation condition acquiring unit 31 is irradiation condition acquiring means for acquiring information on irradiation conditions of laser light on the irradiation object 42. Specifically, the irradiation condition acquiring unit 31 acquires the number of wavelengths xₜ (xₜ=2 in the example shown in FIG. 1) of laser light to be input to the spatial light modulator 20, respective values of the xₜ wavelengths λₓ (x=1, . . . , and xₜ), and incident conditions (for example, an incident intensity distribution, an incident phase distribution) of the laser light at each wavelength λₓ to the spatial light modulator 20, as irradiation conditions of the laser light (an irradiation condition acquiring step). The number of wavelengths xₜ is set as an integer of 1 or more, and is set as an integer of 2 or more in the case of simultaneous irradiation at plural wavelengths.

The light condensing condition setting unit 32 is light condensing condition setting means for setting light condensing conditions of laser light on the irradiation object 42. Specifically, the light condensing condition setting unit 32 sets the number of light condensing points sₜ on which light condensing irradiation of the laser light output from the spatial light modulator 20 is performed, and a light condensing position, a wavelength λₓ of the laser light to be condensed, and a light condensing intensity for each of the sₜ light condensing points (s=1, . . . , and sₜ), as light condensing conditions of the laser light (a light condensing condition setting step). The number of light condensing points sₜ is set as an integer of 1 or more, and is set as an integer of 2 or more in the case of simultaneous irradiation on multiple points.

In addition, acquisition of irradiation conditions by the acquiring unit 31 and setting of light condensing conditions by the setting unit 32 are performed automatically or manually by an operator based on information prepared in advance in the light modulation control device 30, information input from the input device 37, information supplied from an external device, and the like.

The control pattern setting unit 33 is control pattern setting means for setting a light condensing control pattern for controlling the light condensing state, as a phase pattern to be provided for the laser light at the wavelength λₓ for each of the sₜ light condensing points s. Here, for example, in the case where an attempt is made to perform light condensing irradiation of the laser light at the wavelength λₓ in a desired light condensing pattern (an intensity distribution pattern) on the light condensing point s, a phase pattern corresponding to the light condensing pattern is set (a control pattern setting step). This setting of a phase pattern for light condensing control is performed as necessary for each light condensing point and each wavelength.

The modulation pattern designing unit 34 is modulation pattern designing means for designing a CGH to be a modulation pattern to be presented in the spatial light modulator 20 in consideration of the light condensing control pattern set in the control pattern setting unit 33. Specifically, the modulation pattern designing unit 34 refers to the irradiation conditions acquired in the acquiring unit 31, the light condensing conditions set in the setting unit 32, and the light condensing control pattern set in the setting unit 33, and designs a modulation pattern for performing light condensing irradiation on a desired light condensing point with laser light at a desired wavelength based on those conditions (a modulation pattern designing step).

In particular, in the modulation pattern designing unit 34 in the present embodiment, in the design of a modulation pattern to be presented in the spatial light modulator 20, a design method in which a plurality of two-dimensionally arrayed pixels in the spatial light modulator 20 is assumed, and which focuses on an effect on a light condensing state of the laser light on the light condensing point s by changing a phase value of one pixel (corresponding to one pixel assumed in the spatial light modulator 20, and in the case where the spatial light modulator 20 has a pixel structure composed of a plurality of two-dimensionally arrayed pixels, one pixel thereof) in a modulation pattern to be presented in the plurality of pixels is used. Then, the phase value of the one pixel is changed so as to bring its light condensing state closer to a desired state, and such phase value changing operations are performed for all the pixels (at least all the pixels to which the light is incident) in the modulation pattern, thereby designing an optimum modulation pattern.

Further, in this modulation pattern designing unit 34, in the above-described phase value changing operations for the respective pixels, when evaluating the light condensing state of the laser light on the light condensing point, for propagation of light at a wavelength λₓ from a pixel j in the modulation pattern of the spatial light modulator 20 to the light condensing point s, a wave propagation function φ_{js,x} is not directly used, but a propagation function φ_{js,x}′ that a phase pattern opposite to a light condensing control pattern φ_{js-pat,x} which is set in the control pattern setting unit 33 is added to the propagation function λ_{js,x}, which is provided by the following formula

φ_{js,x}′=φ_{js,x}−φ_{js-pat,x}

is used. Thereby, the light condensing control pattern set for each light condensing point and each wavelength is reflected into the modulation pattern and the light condensing irradiation conditions of the laser light thereby.

The light modulator drive control unit 35 is drive control means for drive-controlling the spatial light modulator 20 via the driving device 28, to present the modulation pattern designed by the modulation pattern designing unit 34 to the plurality of pixels in the spatial light modulator 20. Such a drive control unit 35 is provided as necessary in the case where the light modulation control device 30 is included in the laser light irradiation device 1A.

It is possible to achieve processing corresponding to the control method executed in the light modulation control device 30 shown in FIG. 2 by a light modulation control program for causing a computer to execute light modulation control. For example, the light modulation control device 30 may be composed of a CPU for operating the respective software programs necessary for the processing of light modulation control, a ROM in which the above-described software programs and the like are stored, and a RAM in which data is temporarily stored during program execution. In such a configuration, by executing a predetermined control program by the CPU, it is possible to achieve the light modulation control device 30 described above.

Further, the above-described program for causing the CPU to execute light modulation control by use of the spatial light modulator 20, in particular, each processing for designing a modulation pattern to be presented in the spatial light modulator 20, may be recorded in a computer readable recording medium, so as to be distributed. As such a recording medium, for example, a magnetic medium such as a hard disk or a flexible disk, an optical medium such as a CD-ROM or a DVD-ROM, a magnetooptic medium such as a floptical disk, or a hardware device such as a RAM, a ROM, and a semiconductor nonvolatile memory, which are specially arranged so as to execute or store program instructions, and the like are included.

The effects of the light modulation control method, the light modulation control program, the light modulation control device 30, and the laser light irradiation device 1A according to the present embodiment will be described.

In the light modulation control method, the control program, and the control device 30 shown in FIG. 1 and FIG. 2, for light condensing irradiation with laser light by use of the spatial light modulator 20, information on the number of wavelengths xₜ of the laser light, respective values of the xₜ wavelengths λₓ, and incident conditions (for example, an incident amplitude, an incident phase) of the laser light at each wavelength λₓ to the spatial light modulator 20 is acquired, and light condensing conditions including the number of light condensing points sₜ of the laser light, and a light condensing position, a wavelength λₓ of the laser light to be condensed, and a light condensing intensity on each light condensing point s are set. Then, in the control pattern setting unit 33, a phase pattern for light condensing control to be provided for the laser light at the wavelength λₓ is set for each light condensing point s, and in the modulation pattern designing unit 34, a modulation pattern is designed in consideration of the light condensing control patterns. Thereby, it is possible to preferably control the light condensing irradiation conditions of the laser light at the wavelength λₓ to be condensed on each light condensing point s, respectively.

Moreover, for the design of a modulation pattern in such a configuration, specifically, a pixel structure of a plurality of two-dimensionally arrayed pixels is assumed in the spatial light modulator 20. Then, a design method focusing on an effect on a light condensing state of the laser light on the light condensing point s by changing the phase value of one pixel in the modulation pattern is used, and in an evaluation of the light condensing state of the laser light at a wavelength λₓ, a propagation function φ_{js,x} from a pixel j in the spatial light modulator to the light condensing point s is not used directly, but a propagation function φ_{js,x}′ that a phase pattern opposite to the light condensing control pattern φ_{js-pat,x} is added is used, to evaluate the light condensing state.

In accordance with such a configuration, it is possible to reliably reflect the light condensing control pattern set for each light condensing point s and wavelength λₓ respectively into a modulation pattern to be finally obtained, which makes it possible to preferably achieve light condensing control of the laser light at a sufficient degree of freedom. In addition, with respect to the pixel structure assumed in the spatial light modulator 20, in the case where a spatial light modulator having a plurality of two-dimensionally arrayed pixels is used as the spatial light modulator 20, the pixel structure may directly be applied to the design of a modulation pattern.

Further, in the laser light irradiation device 1A shown in FIG. 1, the laser light irradiation device 1A includes the laser light source unit 10 functioning as a laser light source for supplying laser light with xₜ wavelengths λₓ, the phase-modulation type spatial light modulator 20, and the light modulation control device 30 having the above-described configuration. In accordance with such a configuration, the light condensing control pattern set for each light condensing point s and wavelength λₓ is reliably reflected into a modulation pattern to be finally obtained by the control device 30, which makes it possible to preferably achieve light condensing control of the laser light at a sufficient degree of freedom, and it is possible to preferably achieve light condensing irradiation of the laser light on the light condensing points s set on the irradiation object 42, and operations such as processing, observations, and the like of the object 42 thereby. Further, as described above, such a laser light irradiation device may be used as, for example, a laser processing device, a laser microscope, or the like.

Here, an application of a phase pattern opposite to a light condensing control pattern to a propagation function will be briefly described. The laser light reaching a certain pixel j on the spatial light modulator (SLM) is phase-modulated by the SLM, and is further propagated, to reach a certain light condensing point s. In the case where a phase pattern opposite to the light condensing control pattern is provided for a wave propagation function representing propagation of light from a pixel j to the light condensing point s, because the propagation is different from ideal propagation, the light does not directly reach a desired light condensing point s.

In order to cause the light to reach the desired light condensing point s, it is necessary to cancel the phase pattern opposite to the light condensing control pattern provided for the propagation function. For that purpose, a light condensing control pattern for canceling the opposite phase pattern is to be provided. Accordingly, when designing a CGH, a phase pattern opposite to the light condensing control pattern is purposely added to the propagation function, thereby it is possible to design a CGH in which the light condensing control pattern is incorporated.

Further, in such a configuration, for example, in view of light condensing control of laser light at plural wavelengths, provided that a light condensing control pattern is changed at each wavelength, a propagation function to which an opposite phase pattern is provided differs at each wavelength. Accordingly, a light condensing control pattern for canceling a propagation function is added to light at a wavelength using a propagation function to which a phase pattern opposite to a light condensing control pattern is provided, and on the other hand, for example, light at a wavelength using an ideal propagation function is condensed without being affected by the phase pattern.

In the light modulation control device 30 and the laser light irradiation device 1A having the above-described configuration, a configuration in which the number of wavelengths xₜ of the laser light is set to a plural number may be used for acquisition of irradiation conditions in the acquiring unit 31. As described above, a method of designing a modulation pattern by use of a propagation function φ_{js,x}′ to which a phase pattern opposite to a light condensing control pattern is added, is particularly effective in the point that it is possible to control the light condensing irradiation conditions at each wavelength in control of light condensing irradiation conditions of laser light containing the light components of the plural wavelengths λ₁, λ₂, and λₓₜ, and the like, in this way.

Further, in the case where light condensing irradiation of laser light containing plural wavelength components as described above is performed, the configuration in which the modulation pattern is designed in consideration of wavelength dispersion of a refractive index in the spatial light modulator 20 in the design of a modulation pattern in the designing unit 34 can be used. Thereby, it is possible to more accurately control the light condensing irradiation conditions of the laser light at the wavelength λₓ on each light condensing point s for the respective wavelengths λₓ different from each other.

Further, with respect to the design of a modulation pattern in the designing unit 34, it is preferable that, given that an incident amplitude of the laser light at the wavelength λₓ to the pixel j in the spatial light modulator 20 is A_{j-in,x}, a phase is φ_{j-in,x}, and a phase value for the laser light at the wavelength λₓ in the pixel j is φ_{j,x}, a complex amplitude U_{s,x} indicating the light condensing state of the laser light at the wavelength λₓ on the light condensing point s is determined by the following formula.

$$\begin{matrix}{U}_{s , x} = {A}_{s , x} exp ( i {φ}_{s , x} ) \\ = {Σ}_{j} {A}_{j - in , x} exp ( {iφ}_{js , x}^{′} ) \times exp ( i ( {φ}_{j , x} + {φ}_{j - in , x} ) )\end{matrix}$$

Thereby, it is possible to preferably evaluate a light condensing state of the laser light at each wavelength λₓ on the light condensing point s.

Here, the incident amplitude A_{j-in,x} of the laser light at the wavelength λₓ to the pixel j is in the relationship of

I_{j-in,x}=|A_{j-in,x}|²

for an incident intensity I_{j-in,x}. Further, in the complex amplitude U_{s,x} A_{s,x} is an amplitude, and φ_{s,x} is a phase. Further, in the case where the laser light incident to the spatial light modulator 20 is a plane wave, the incident phase φ_{j-in,x} can be disregarded.

Further, from the above-described formula, it is considered that the complex amplitude U_{s,x} on the light condensing point s after propagation is the sum of the complex amplitudes of the respective pixels j multiplied by the propagation functions, and its amplitude A_{s,x} is affected independently at each pixel in the modulation pattern. That is, by changing a phase value of each pixel in the modulation pattern to be presented in the SLM, it is possible to change the amplitude A_{s,x}. With use of this, it is possible to preferably design a CGH used for a modulation pattern by a design method focusing on an effect by changing the phase value of one pixel described above.

As a specific configuration in the design of a modulation pattern, a configuration in which a phase value is changed according to a value analytically determined based on a phase of a complex amplitude indicating the light condensing state of the laser light at the wavelength λₓ on the light condensing point s, the propagation function φ_{js,x}′, a phase value φ_{j,x} of the pixel j before change, and an incident phase φ_{j-in,x} of the laser light may be used for changing the phase value of the pixel j in the modulation pattern. As a design method of analytically updating a phase value in this way, there is, for example, an ORA (Optimal Rotation Angle) method.

Or, for the design of a modulation pattern, a configuration in which a phase value is changed according to a value determined by searching by use of any method of a hill-climbing method, a simulated annealing method, and a genetic algorithm may be used for changing the phase value of the pixel j in the modulation pattern. Here, in the genetic algorithm, operations such as a mutation that a certain pixel is selected to change its pixel value, and a crossover that two pixels are selected to exchange their pixel values are performed, and the above-described design method focusing on an effect on a light condensing state of laser light at a light condensing point by changing the phase value of one pixel in the modulation pattern includes a method of performing such operations. In addition, the modulation pattern design method will be described in detail later.

Further, in the light modulation control device 30 shown in FIG. 2, in addition to the configuration for designing a modulation pattern, the light modulator drive control unit 35 which drive-controls the spatial light modulator 20, and presents a modulation pattern designed by the designing unit 34 to the spatial light modulator 20 is provided. Such a configuration is effective in the case where the control device 30 is used in a manner incorporated in the laser light irradiation device 1A as shown in FIG. 1. Further, such a drive control unit 35 may also be provided as a separate device from the light modulation control device 30.

Further, for example, in the case where a glass medium is processed by laser light irradiation to prepare an optical integrated circuit, one or a plurality of new CGHs may be designed after one or several laser light irradiations, to switch a modulation pattern to be presented in the spatial light modulator 20. Or, in the case where the processing content has been determined, a plurality of modulation patterns necessary for laser processing may be designed in advance. Further, in the case where a DOE is singularly used, there is no need to have a driving device because a DOE is a static pattern. Further, in the case where a pattern is dynamically switched by use of a plurality of DOEs, a switching device is used in place of a driving device.

In addition, in the laser light irradiation device 1A shown in FIG. 1, the configuration of the laser scanning microscope is exemplified as described above. Such a laser microscope is preferably applicable to a super-resolution microscope which is considered to go beyond the diffraction limit, such as an STED (stimulated emission depletion) microscope using laser light sources at two or more wavelengths, or a PALM (photoactivated localization microscopy) microscope.

For example, in an STED microscope, light sources at two wavelengths of an excitation light source which transfers fluorescent molecules from the ground state to a specific excitation state, and a control light source which transfers fluorescent molecules from the specific excitation state to another level are used (refer to Patent Document 4, and Non-Patent Documents 7 and 8). Further, in this case, light condensing irradiation of control laser light from the control light source is performed so as to be a ring-shaped light condensing shape such that a diameter of a shadow inside the condensed light is smaller than the diffraction limit of the excitation light. In such a configuration, only the excitation light inside the ring-shaped light condensing shape of the control light is to contribute to fluorescent observation, and the fluorescing region is limited, and as a result, it is possible to obtain a super-resolution lower than the diffraction limit.

As problems in such an STED microscope, there may be cited an alignment of excitation light and control light including an optical axis direction under a high NA objective lens, a long measurement time, phase modulations for respectively generating ring-shaped control light beams for various wavelengths output from a wavelength variable laser or the like, an increase in size of the optical system due to its complicated configuration, and the like. Meanwhile, in accordance with the laser light irradiation device 1A having the above-described configuration which is capable of achieving light condensing control of laser light at a sufficient degree of freedom for each light condensing point and wavelength, it is possible to construct the optical system by use of SLMs which are less than the number of light sources, which brings about the effects of simplification of a configuration and an improvement in operability of the super-resolution microscope, and the like. Further, it is possible to obtain such effects in the same way in a laser processing device and the like.

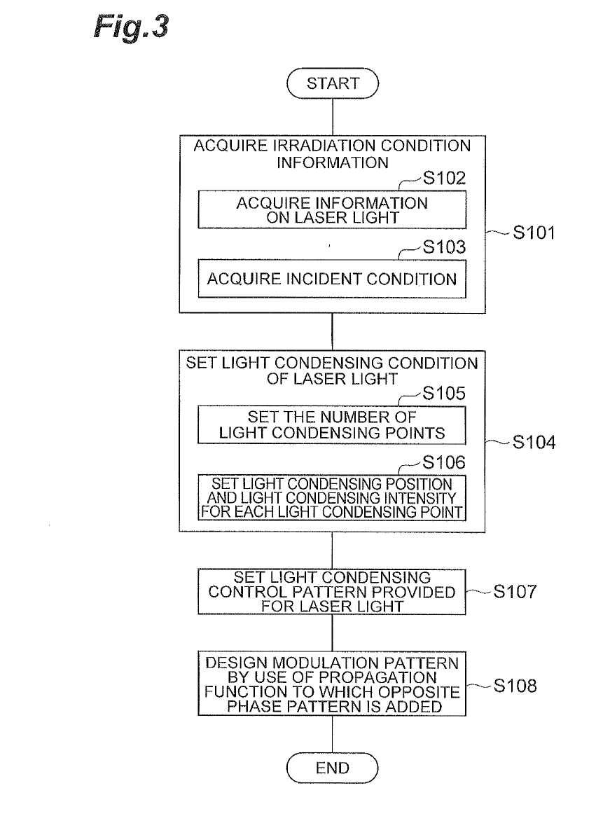

The light modulation control method and the modulation pattern design method executed in the laser light irradiation device 1A and the light modulation control device 30 shown in FIG. 1 and FIG. 2 will be further described along with their specific examples. FIG. 3 is a flowchart showing an example of the light modulation control method executed in the light modulation control device 30 shown in FIG. 2.

In the control method shown in FIG. 3, first, information on the irradiation conditions of laser light supplied from the laser light source unit 10 to the object 42 is acquired (step S101). Specifically, information on the laser light including the number of wavelengths xₜ of the laser light, and respective values of the xₜ wavelengths λₓ=λ₁, . . . , and λₓₜ is obtained (S102). The number of wavelengths xₜ is the number of the laser light sources in the case where individual laser light sources are used at each wavelength. Further, when there is information necessary for derivation of a CGH, such as an NA, a focal point distance f, and the like of the objective lens 25 other than the above-described information, these are acquired in addition to the information on the laser light.

Further, incident conditions of the laser light supplied from the laser light source unit 10 to the spatial light modulator 20 are acquired for each wavelength λₓ (step S103). As incident conditions in this case, for example, there is an incident pattern of the laser light at the wavelength λₓ, to the spatial light modulator 20. An incident pattern is provided as an incident light intensity distribution by an incident laser light intensity

Iᵢₙ(xⱼ,yⱼ,λₓ)=I_{j-in,x}

for a pixel j at a position (xⱼ, yⱼ) among the plurality of two-dimensionally arrayed pixels in the spatial light modulator 20. Or, an incident pattern of the laser light may be acquired as an incident light amplitude distribution by an amplitude A_{j-in,x}. Further, in case of necessity, an incident phase φ_{j-in,x} of the laser light as well is acquired in the same way.

Next, light condensing conditions of the laser light on the irradiation object 42 are set (S104). First, the number of a single or a plurality of light condensing points sₜ at which light condensing irradiation of the laser light phase-modulated in the spatial light modulator 20 is performed on the irradiation object 42 is set (S105). Here, in the laser light irradiation device 1A according to the above-described configuration, it is possible to obtain a plurality of light condensing points as necessary according to a modulation pattern to be presented in the spatial light modulator 20.

Further, a light condensing position γₛ=(uₛ, vₛ, zₛ) of the laser light, a single or plural wavelengths λₓ of the laser light to be condensed, and a desired light condensing intensity I_{s-des,x} are set for each of the sₜ light condensing points s=1, . . . , and sₜ on the object 42 (S106). In addition, with respect to the wavelength of the laser light to be condensed, in the case where a single wavelength is made to correspond to each light condensing point s, given that the wavelength is λₛ, a light condensing parameter γₛ=(uₛ, vₛ, zₛ, λₛ) may be set. Further, a light condensing intensity of the laser light on each light condensing point is not limited to the setting according to an absolute value of an intensity, and may be set according to, for example, a relative ratio of the intensity.

Next, a light condensing control pattern for controlling a light condensing state of the laser light is set as a phase pattern to be provided for the laser light at the wavelength λₓ for each of the sₜ light condensing points s (S107). Then, in consideration of the light condensing control patterns set in step S107, with reference to the irradiation conditions and the light condensing conditions of the laser light which are acquired and set in steps S101 and S104, a CGH serving as a modulation pattern to be presented in the spatial light modulator (SLM) 20 is designed by use of a propagation function to which a phase pattern opposite to the light condensing control pattern is added (S108).

The modulation pattern design method executed in step S108 in the flowchart of FIG. 3 will be described in detail. Hereinafter, as an example of the design method focusing on an effect by a phase value of one pixel in the modulation pattern to be presented in the plurality of pixels in the SLM 20, a design method by use of an ORA method will be described (refer to Patent Document 3, and Non-Patent Documents 1 and 2).

Here, in general, there are a plurality of design methods of a CGH used as a modulation pattern in the SLM, and for example, an iterative Fourier method and the like may be cited. First, an iterative Fourier transform method is a method in which, two surfaces of an SLM surface and a diffractive surface are prepared, to propagate light between the respective surfaces by a Fourier transform and an inverse Fourier transform. Then, the amplitude information of the respective surfaces is replaced in each propagation, to finally acquire a phase distribution.

Further, as another CGH design method, two methods of a ray tracing method and a design method focusing on an effect by one pixel may be cited. As a ray tracing method, there is a superposition-of-lens method (S method: Superposition of Lens). This method is effective in the case where there is not much overlapping of wave fronts from a light condensing point, meanwhile, when overlapping of wave fronts is increased, the intensity of light propagating to a light condensing point among the laser light intensities incident to the SLM is drastically reduced, or it is not possible to control the intensity in some cases. Therefore, there is an iterative S method which improved the S method.

On the other hand, the design method focusing on an effect by one pixel in a CGH is a method of appropriately selecting one pixel in a CGH, and changing a phase value of each pixel, to perform designing the CGH, and there are a search type method and an analysis type method according to a method of determining a phase of one pixel.

In this design method, a phase value of a certain pixel in a CGH is changed as a parameter, and a modulation laser light is propagated by use of a wave propagation function by the Fresnel diffraction or the like, to examine how values (for example, values of an amplitude, an intensity, and a complex amplitude) indicating a light condensing state at a desired light condensing point change. Then, a phase value by which the light condensing state on the light condensing point is brought closer to a desired result is adopted. Such an operation is performed on one pixel by one pixel on at least all the pixels to which light is incident.

After the operations are completed on all the pixels, in an analysis type method, after it is confirmed how a phase at a desired position changes based on the results of the phase-modulations of all the pixels, the process returns to the first pixel, to change a phase one pixel by one pixel by use of the phase at the desired position. Further, in a search type method, the process returns to the first pixel without performing confirmation. As a search type method, for example, there are a hill-climbing method, a simulated annealing method (SA: Simulated Annealing), and a genetic algorithm (GA: Genetic Algorithm), and the like (refer to Non-Patent Documents 3 and 4).

An ORA (Optimal Rotation Angle) method which will be hereinafter described is an optimization algorithm using an analysis type method. In this method, a change and an adjustment in a phase value of each pixel in a modulation pattern are carried out according to a value analytically determined based on a phase φ_{s,x} of a complex amplitude indicating a light condensing state on the light condensing point s, a phase φ_{js,x} of the propagation function, a phase value φ_{j,x} of the pixel j before change, and an incident phase φ_{j-in,x} of the laser light. In particular, in the design method in the present embodiment, as a wave propagation function, in place of the usual φ_{js,x}, a propagation function φ_{js,x}′ to which a phase pattern opposite to the light condensing control pattern is added is used.

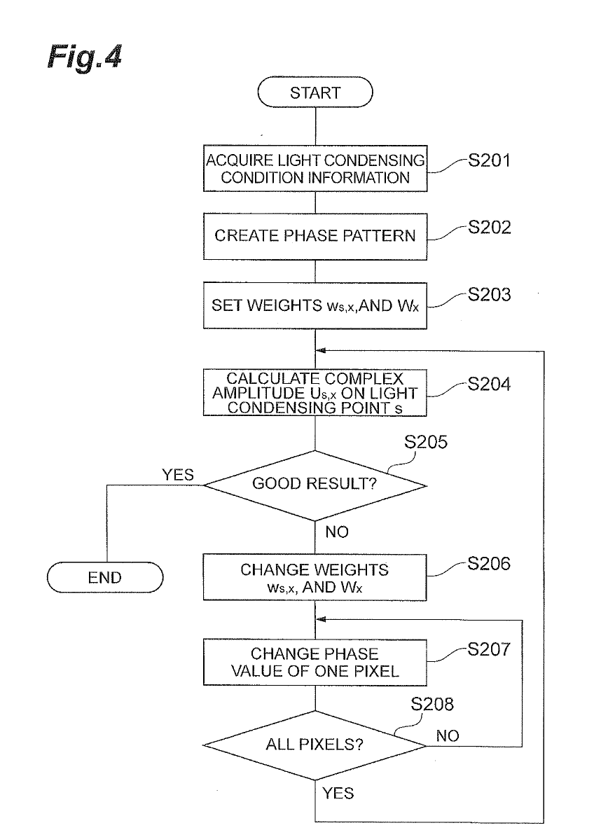

FIG. 4 is a flowchart showing an example of a modulation pattern design method executed in the light modulation control device 30 shown in FIG. 2. First, information on the set light condensing conditions for light condensing irradiation of laser light on the irradiation object 42 performed via the spatial light modulator 20 is acquired (step S201). As the light condensing conditions acquired here, there are the number of light condensing points sₜ, a light condensing position γₛ (uₛ, vₛ, zₛ) of each light condensing point s, a wavelength λₓ of the laser light to be condensed, and a desired light condensing intensity I_{s-des,x}.

Next, a phase pattern serving as an initial condition for the design of a COB used as a modulation pattern to be presented in the SLM 20 is created (S202). This phase pattern is created by, for example, a method in which a phase value φⱼ of a pixel j in the CGH is made into a random phase pattern. Because the design of a CGH by an ORA is an optimization technique, this method is used for the purpose of preventing from leading to a specific minimum solution due to a random phase. In addition, in the case where the possibility of leading to a specific minimum solution can be disregarded, for example, it may be set to a uniform phase pattern or the like. Further, in the case where light condensing irradiation of laser light at plural wavelengths is performed, a predetermined wavelength λₐ among the wavelengths λ₁ to λₓₜ of the laser light is set to a reference wavelength, and a phase value φ_{j,a} for this reference wavelength λₐ is set.

Next, in the case where the number of light condensing points is set to a plural number (sₜ≧2), a weight w_{s,x} which is a parameter for adjusting a light condensing intensity ratio among those light condensing points s=1 to sₜ is set to w_{s,x}=1 as its initial condition (S203). In addition, this weight w_{s,x} exists by the number of wavelengths xₜ (by the number of laser light sources), which are respectively arrayed in 1×sₜ. Further, in the case of a single light condensing point (sₜ=1), it is not necessary to set a weight w_{s,x}. Further, in the case where the number of wavelengths is set as a plural number (xₜ≧2), a weight Wₓ which is a parameter for adjusting a light quantity ratio among the plural wavelengths is set to Wₓ=1 as its initial condition.

When the settings of the phase pattern φ_{j,a} of the CGH and the weights w_{s,x} and Wₓ are completed, a complex amplitude U_{s,x} indicating a light condensing state of the laser light on the light condensing point s is calculated (S204). Specifically, for the laser light at the wavelength λₓ, a complex amplitude U_{s,x}=A_{s,x}exp(iφ_{s,x}) which the laser light at the wavelength λₓ applies on the light condensing point s is determined by the following formula (1) representing lightwave propagation,

$$\begin{matrix}[ Formula 1 ] & \\ \begin{matrix}{U}_{s , x} = {A}_{s , x} exp ( i {φ}_{s , x} ) \\ = {Σ}_{j} {A}_{j - in , x} exp ( {iφ}_{js , x}^{′} ) exp ( i ( {φ}_{j , x} + {φ}_{j - in , x} ) )\end{matrix} & ( 1 )\end{matrix}$$

Here, A_{j-in,x} is an incident amplitude of the laser light at the wavelength λₓ onto the pixel j in the SLM 20, φ_{j-in,x} is an initial phase when the laser light at the wavelength λₓ is incident to the pixel j. Further, φ_{j,x} is a phase value for the laser light at the wavelength λₓ of the pixel j. This phase value λ_{j,x} is determined by the following formula (2)

[Formula 2]

φ_{j,x}=τ(λₐ,λₓ)×φ_{j,a} (2)

according to the phase value φ_{j,a} for the reference wavelength λₐ described above.

In addition, in this formula (2), τ(λₐ, λₓ) is a correction formula (correction coefficient) in consideration of wavelength dispersion and the like. For example, in the case where the SLM 20 is an LCOS-SLM using a liquid crystal, modulation of a phase of laser light is performed by use of the birefringence characteristics of the liquid crystal, meanwhile, the birefringence of the liquid crystal is not linear with respect to a wavelength λ. Then, in conversion of a phase value, as a correction formula in consideration of the birefringence characteristics of the liquid crystal and the like, the above-described τ(λₐ, λₓ) is used.

Further, in the formula (1), φ_{js,x}′ is a propagation function to which a phase pattern opposite to a light condensing control pattern φ_{js-pat,x} set for the laser light at the wavelength λₓ is added, and is determined as follows.

[Formula 3]

φ_{js,x}′=φ_{js,x}+(−φ_{js-pat,x}) (3)

In addition, the phase pattern φ_{js-pat,x} for light condensing control corresponds to a light condensing pattern of the laser light at the wavelength λₓ to be set on the light condensing point s. Specifically, as such a light condensing control pattern, for example, a phase pattern which is represented by a polynomial such as Laguerre polynomials or Hermite polynomials, a phase pattern which is represented by Zernike polynomials or Legendre polynomials, a CGH pattern for performing multiple-point light condensing, or a CGH pattern for changing a light condensing position, a light condensing shape, or the like may be used.

In this way, by use of the propagation function φ_{js,x}′ to which a phase pattern opposite to a light condensing control pattern is added, it is possible to reliably reflect the light condensing control pattern set for each light condensing point s and wavelength λₓ into a modulation pattern to be finally obtained. For example, as a light condensing control pattern is made to differ at each wavelength, it is thereby possible to obtain a CGH which is capable of providing an arbitrary phase pattern which differs at each wavelength. Further, φ_{js,x} is a propagation function in a finite distance region in the case of assuming a free propagation. As this propagation function φ_{js,x}, for example, the Fresnel diffraction which is an approximation formula of a wave propagation function which is provided by the following formula (4)

$$\begin{matrix}[ Formula 4 ] & \\ {φ}_{js , x} = \frac{{n}_{1} \times π}{{λ}_{x} f} [ {( {u}_{s} - {x}_{j} )}^{2} + {( {v}_{s} - {u}_{j} )}^{2} ] & ( 4 )\end{matrix}$$

may be used. Here, in the above-described formula (4), n₁ is a refractive index of an ambient medium such as air, water, or oil, and f is a focal point distance. Further, it is clear from this formula (4) that an ideal propagation function φ_{js,x} differs according to a wavelength λₓ.

In addition, as a propagation function φ_{js,x} of free propagation, for example, various expression formulas such as an approximation formula of the Fresnel diffraction described above, an approximation formula of the Fraunhofer diffraction, or a solution of the Helmholtz equation may be used. Further, in the formula (1) of a complex amplitude and the formula (3) of a propagation function described above, given that a light condensing control pattern to be added to a wave propagation function is φ_{js-pat,x}=0, the propagation function becomes φ_{js,x}′=φ_{js,x}, which brings about a normal calculation formula of a complex amplitude which has been used for a conventional ORA method.

Next, it is judged whether or not a desired result has been obtained in the design of a CGH by the above-described method (S205). As a judgment method in this case, for example, a method in which a light condensing intensity I_{s,x}=|A_{s,x}|² obtained by the light at the wavelength λₓ on each light condensing point s and a desired intensity I_{s-des,x} are compared by the following formula (5)

$$\begin{matrix}[ Formula 5 ] & \\ max ( \frac{{I}_{s - des , x}}{{I}_{s , x}} ) \leq ɛ & ( 5 )\end{matrix}$$

and it is judged by whether or not an intensity ratio is less than or equal to a predetermined value ε for all the light condensing points s and the wavelengths λₓ, may be used. Further, a judgment may be made by, not the light condensing intensity I_{s,x}, but an amplitude A_{s,x}, a complex amplitude U_{s,x}, and the like.

Or, in the flowchart of FIG. 4, a method in which it is judged by conditions of, such as, whether or not a specified number of loops of changing a phase value and calculating a complex amplitude, and the like are performed, may be used. In the case where it is judged that the designed CGH satisfies the necessary conditions for the set light condensing conditions, the design algorithm for a CGH by an ORA is completed. Further, in the case where the conditions are not satisfied, the process proceeds to the following step S206.

In the case where it is judged that the conditions necessary for the completion of the design are not satisfied, first, the values of a weight w_{s,x} for adjusting a light condensing intensity ratio among the light condensing points s, and a weight Wₓ for adjusting a light quantity ratio among the plural wavelengths λₓ are changed by the following formulas (6), (7), and (8) (S206).

$$\begin{matrix}[ Formula 6 ] & \\ {w}_{s , x} = {{w}_{s , x} ( \frac{{I}_{s - des , x}}{{I}_{s , x}} )}^{η} & ( 6 ) \\ [ Formula 7 ] & \\ {W}_{a} = 1 & ( 7 ) \\ [ Formula 8 ] & \\ {W}_{x} = {{W}_{x} ( \frac{{I}_{a}^{ave}}{{I}_{x}^{ave}} )}^{q} & ( 8 )\end{matrix}$$

Here, Wₐ in the formula (7) is a weight at a reference wavelength λₐ. Further, for a parameter η used for updating the weight w_{s,x} in the formula (6), and a parameter q used for updating the weight Wₓ in the formula (8), usually, values of n=approximately 0.25 to 0.35, and q=approximately 0.25 to 0.35 are customarily used in order to prevent the ORA algorithm from becoming unstable. Further, in the formula (8), Iₓ^{ave} is an average of the intensities on all the points at the wavelength λₓ.

Next, a phase value changing operation is performed for each pixel of the CGH such that the light condensing state of the laser light on the light condensing point s is brought closer to a desired state (S207). In an analysis type ORA method, in order to bring a light condensing state closer to a desired state, an amount of phase change Δφ_{j,a} to be added to the phase value φ_{j,a} of the pixel j is, by use of the phase φ_{s,x} of a complex amplitude obtained in the formula (1), the phase φ_{js, x}′ of the propagation function to which the phase pattern opposite to the light condensing control pattern is added, the phase value φ_{j,x} before updating, and the incident phase φ_{j-in,x} of the laser light, analytically determined by the following formula (9)

$$\begin{matrix}[ Formula 9 ] & \\ {Δφ}_{j , a} = arctan ( \frac{{P}_{2}}{{P}_{1}} ) & ( 9 )\end{matrix}$$

and judgment is made. Here, the following formulas

$$\begin{matrix}[ Formula 10 ] & \\ {P}_{1} = {\sum }_{x} {\sum }_{s} {W}_{x} {w}_{s , x} {A}_{j - in , x} cos {Φ}_{js , x} & ( 10 ) \\ [ Formula 11 ] & \\ {P}_{2} = {\sum }_{x} {\sum }_{s} {W}_{x} {w}_{s , x} {A}_{j - in , x} sin {Φ}_{js , x} & ( 11 ) \\ [ Formula 12 ] & \\ \begin{matrix}{Φ}_{js , x} = {φ}_{s , x} - ( {φ}_{js , x}^{′} + {φ}_{j , x} + {φ}_{j - in , x} ) \\ = {φ}_{s , x} - ( {φ}_{js , x} - {φ}_{js - pat , x} + τ ( {λ}_{a} , {λ}_{x} ) \times {φ}_{j , a} + {φ}_{j - in , x} )\end{matrix} & ( 12 )\end{matrix}$$

are held. A method of analytically determining a phase value in this way has an advantage that a time required for computation is shortened as compared with a method such as the hill-climbing method which determines a phase value by searching.

In addition, with respect to Φ_{js,x} used for determining an amount of phase change Δφ_{j,a}, in a usual ORA method, the following formula (13)

[Formula 13]

Φ_{js,x}=φ_{s,x}−(φ_{js,x}+φ_{j,x}+φ_{j-in,x}) (13)

is used, meanwhile, in an improved ORA method which is described here, in addition to the change in the propagation function described above, in a calculation of this Φ_{js,x} in the update of a phase value as well, the formula (12) to which a phase pattern (−φ_{js-pat,x}) opposite to an arbitrary light condensing control pattern is provided is used.

As described above, when an amount of phase change Δφ_{j,a} is determined, a phase value φ_{j,a} at a j-th pixel in the CGH is changed and updated by the following formula (14).

[Formula 14]

φ_{j,a}=φ_{j,a}+Δφ_{j,a} (14)

Further, at this time, a phase value φ_{j,x} for each wavelength λₓ is determined by the formula (2).

Then, it is confirmed whether or not a phase value changing operation is performed on all the pixels (S208), and when the changing operation has not been completed, it is assumed that j=j+1, a phase value changing operation is performed on the next pixel. On the other hand, when the changing operation for all the pixels has been completed, the process returns to step S204, and a calculation of a complex amplitude U_{s,x} and an evaluation of a light condensing state of the laser light thereby are carried out. Such operations are repeatedly executed, a CGH of a modulation pattern corresponding to the set light condensing conditions is thereby created.

As described above, provided that a CGH is designed by use of a propagation function to which a phase pattern opposite to a light condensing control pattern is added, an arbitrary phase pattern is provided at each wavelength or each light condensing point, which makes it possible to perform light condensing control at a high accuracy under different conditions. For example, in the light condensing control of laser light at plural wavelengths, it is possible to proactively change a light condensing position, a light condensing shape, and the like thereof at each wavelength.

Further, the method of providing a CGH for performing an alignment of a light condensing point, a light condensing shape adjustment, multiple-point light condensing, and the like to a light condensing control pattern has the following advantages. That is, because a phase value is changed for each pixel in the design of a CGH by an ORA method, it takes a longer design time as compared with a design method such as an iterative Fourier method. Further, the design time depends on the number of regeneration points in light condensing irradiation of laser light. In contrast thereto, in a method in which a CGH for performing a position alignment, multiple-point light condensing, and the like is designed in advance, and a phase pattern opposite to the CGH is provided for a propagation function, the multiple points regenerated by the phase pattern are considered as one group. Accordingly, it is possible to decrease the number of light condensing points to be evaluated, from the number of regeneration points to the number of regeneration groups, and it is possible to shorten the time for the design of a CGH. In addition, it is necessary to evaluate a difference in the number of regeneration points among the groups in advance.

Moreover, in the case where a spatial light modulator which is capable of dynamically switching a modulation pattern to be presented is used, it is easy to perform an alignment of a position in the depth direction of a light condensing point or the like by performing feedback control or the like. Further, for example, a plurality of light condensing points are created from a single light source by use of a spatial light modulator, and a plurality of detectors are prepared so as to correspond to those, thereby it is possible to shorten a measurement time.

In addition, in the specific example described above, an amount of change Δφ_{j,a} to be added to a phase value of the pixel j is analytically deter mined by the formulas (9) to (12), however, for the calculation of an amount of phase change, specifically, a method other than the above-described method may be used. For example, a method of determining an amount of phase change Δφ_{j,x} at each wavelength λₓ may be used by the following formula (15).

$$\begin{matrix}[ Formula 15 ] & \\ {Δφ}_{j , x} = arctan ( \frac{{P}_{2}}{{P}_{1}} ) & ( 15 )\end{matrix}$$

Here, the following formulas

$$\begin{matrix}[ Formula 16 ] & \\ {P}_{1} = {\sum }_{s} {W}_{x} {w}_{s , x} {A}_{j - in , x} cos {Φ}_{js , x} & ( 16 ) \\ [ Formula 17 ] & \\ {P}_{2} = {\sum }_{s} {W}_{x} {w}_{s , x} {A}_{j - in , x} sin {Φ}_{js , x} & ( 17 )\end{matrix}$$

are held. Further, with respect to Φ_{js,x}, Φ_{js,x} shown in the formula (12) is used.

Further, in this case, the phase value φ_{j,a} is changed and updated by the following formula (18).

$$\begin{matrix}[ Formula 18 ] & \\ {φ}_{j , a} = {φ}_{j , a} + κ ( {λ}_{a} , {λ}_{x} ) {\sum }_{x} {Δφ}_{j , x} & ( 18 )\end{matrix}$$

In addition, in this formula (18), κ(λₐ, λₓ) is a parameter for adjusting an amount of phase change Δφ_{j,x} which differs at each wavelength. This parameter may be omitted if not necessary.

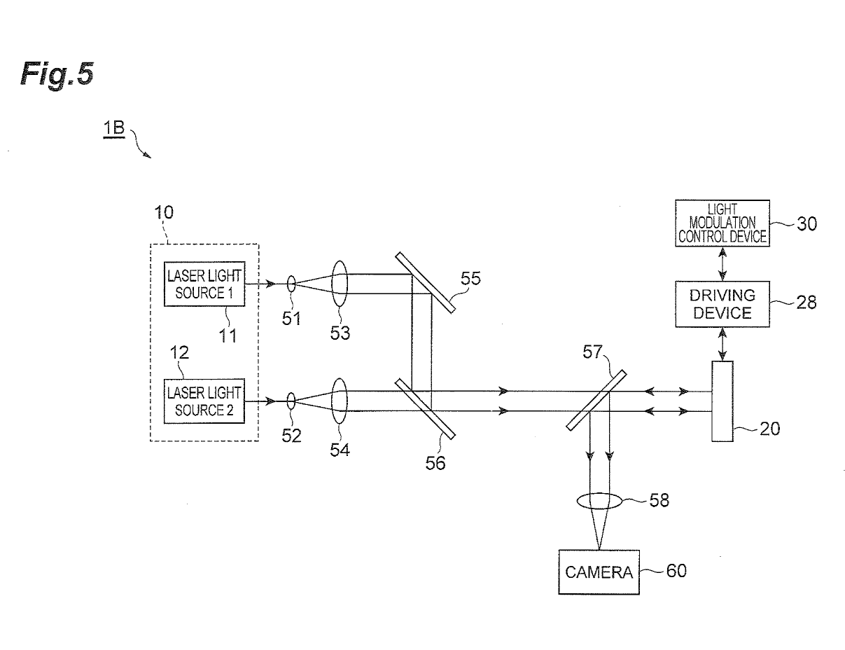

The effects of light condensing control of laser light by the light modulation control device 30 and the laser light irradiation device 1A according to the above-described embodiment will be described along with the specific example. Here, a laser light irradiation device 1B is configured by an optical system shown in FIG. 5, and a confirmatory experiment on light condensing control has been carried out by use of this laser light irradiation device 1B.

In the configuration shown in FIG. 5, the laser light source unit 10 is composed of the laser light source 11 which supplies laser light at a wavelength of 532 nm, and the laser light source 12 which supplies laser light at a wavelength of 633 nm. The laser light from the laser light source 11 is expanded by a spatial filter 51 and a collimator lens 53, and reflected by a mirror 55, to be thereafter reflected by a dichroic mirror 56. Further, the laser light from the laser light source 12 is expanded by a spatial filter 52 and a collimator lens 54, to thereafter pass through the dichroic mirror 56. Thereby, the laser light beams from the laser light sources 11 and 12 are multiplexed on the dichroic mirror 56.

The laser light from the dichroic mirror 56 passes through a half mirror 57, to be phase-modulated by the reflective type spatial light modulator 20. Then, the reflected laser light from the spatial light modulator 20 is reflected by the half mirror 57, and its condensed light image is imaged by a camera 60 via a lens 58. With this condensed light image of the laser light, it is possible to confirm light condensing control by the spatial light modulator 20.

Further, with respect to light condensing control conditions by a phase pattern to be provided for the laser light in the spatial light modulator 20, the light condensing positions (regeneration positions) of the laser light at a wavelength of 532 nm and the laser light at a wavelength of 633 nm are shifted in order to increase visibility, and conditions for condensing the laser light at a wavelength of 532 nm into a Gaussian shape, and condensing the laser light at a wavelength of 633 nm into a ring shape are used.

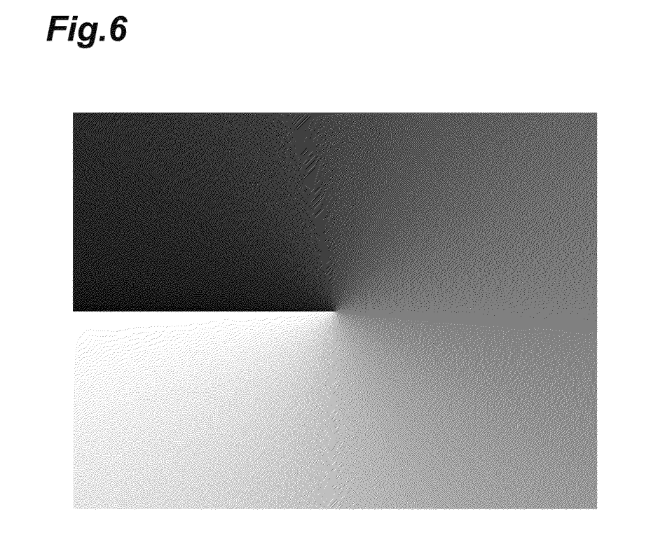

In addition, as a phase pattern for light condensing control to be displayed on the SLM for condensing laser light into a ring shape, for example, a phase pattern of a Laguerre-Gaussian (LG) beam shown in FIG. 6 may be used. In the phase pattern of FIG. 6, white to black portions indicate phase values of 0 to 2π (rad) at a certain wavelength λ, and make a pattern in which the phase spirally rotates from 0 to 2π (rad) centering on a predetermined position. Further, such a phase pattern may be represented by use of Laguerre polynomials as well (refer to Non-Patent Document 6).

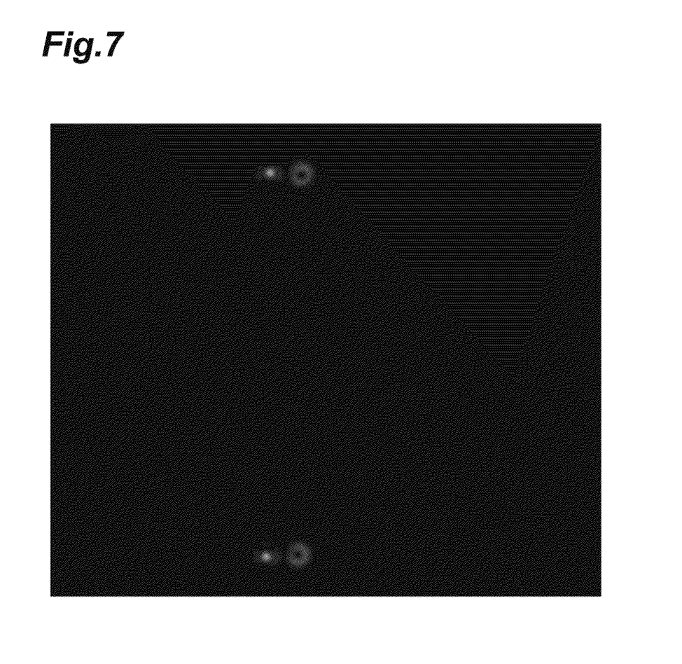

FIG. 7 shows a condensed light image of laser light obtained by such a configuration and setting. As shown in this FIG. 7, according to a modulation pattern designed by the method described above, it is possible to preferably regenerate a condensed light spot of a Gaussian shape of laser light at a wavelength of 532 nm, and a condensed light spot of a ring shape of laser light at a wavelength of 633 nm, respectively. Further, it is possible to apply such light condensing control conditions to an STED microscope by matching the light condensing positions.

The modulation pattern design method executed in step S108 in the flowchart of FIG. 3 will be further described. In the flowchart of FIG. 4, as an example of the design method focusing on an effect by one pixel in a CGH, a design method using an analysis type ORA method is shown. Meanwhile, as a modulation pattern design method, a search type design method such as a hill-climbing method, a simulated annealing method, or a genetic algorithm may be used as described above.

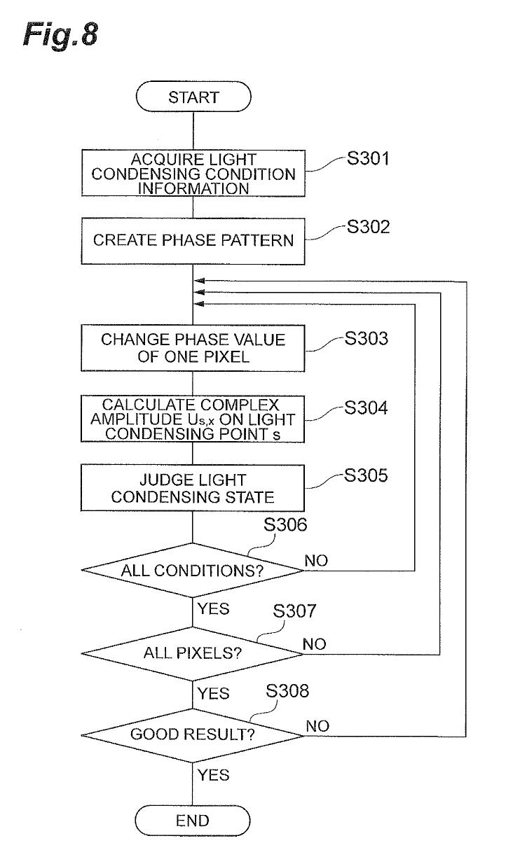

FIG. 8 is a flowchart showing another example of a modulation pattern design method executed in the light modulation control device 30 shown in FIG. 2. In this flowchart, a design method in the case where the hill-climbing method is used is shown as an example of a search type design method. In this method, first, information on set light condensing conditions for light condensing irradiation of laser light onto the irradiation object 42 performed via the SLM 20 is acquired, in the same way as in the case of an ORA method described above (step S301). Next, a phase pattern serving as an initial condition for the design of a CGH to be presented in the SLM 20 is created as, for example, a random phase pattern (S302).

Next, a phase value changing operation of one pixel in the CGH is performed (S303). Moreover, a complex amplitude U_{s,x}=A_{s,x}exp(iφ_{s,x}) indicating a light condensing state of the laser light on the light condensing point s is calculated by use of the formula (1) including the propagation function φ_{js,x}′ to which the phase pattern opposite to the light condensing control pattern is added (S304). After calculating a complex amplitude U_{s,x}, a judgment of the obtained light condensing state is made (S305).

Here, when the amplitude A_{s,x}, the intensity I_{s,x}=|A_{s,x}|², or the complex amplitude U_{s,x} are brought closer to a desired value by switching a phase value of one pixel in the modulation pattern, a phase value at that time is adopted. In the hill-climbing method, for example, a phase value of each pixel in the CUE is switched every 0.1π (rad) from 0π (rad) to a predetermined phase value, for example, switched to 2π (rad), and a propagation is carried out by use of the formula (1) for every switching. Then, a phase value by which an intensity on the light condensing point s is maximized is determined by searching.

Next, it is determined whether or not switching of a phase value of one pixel has been confirmed under all the conditions (S306), and when it has not been confirmed, the process returns to step S303. Moreover, it is judged whether or not the phase value changing operations of one pixel, judging a light condensing state and the like have been performed on all the pixels (S307), and when it has not been performed, it is assumed that the pixel number is j=j+1, the process returns to step S303, and a necessary operation is performed on the next pixel.

When the necessary operations have been performed on all the pixels, it is judged whether or not a desired result has been obtained in the design of the CGH (S308). As a judgment method in this case, in the same way as the case of an ORA method, for example, a method of judging by whether or not the values of a light condensing intensity, an amplitude, a complex amplitude, and the like obtained on each light condensing point are within the allowable ranges may be used. Or, in the flowchart of FIG. 8, a method in which it is judged by conditions of, such as, whether or not a specified number of loops of changing a phase value, judging a light condensing state, and the like is performed, may be used. In the case where the necessary conditions are satisfied, the design algorithm for a CGH is completed. In the case where the conditions are not satisfied, the process returns to step S303, to repeat searches from the first pixel.

The light modulation control method, the control program, the control device, and the laser light irradiation device according to the present invention are not limited to the above-described embodiment and the configuration examples, and various modifications thereof are possible. For example, a configuration of an optical system including laser light sources and a spatial light modulator is not limited to the configuration example shown in FIG. 1, and specifically, various configurations may be used.

Further, in the above-described embodiment, the case where the number of wavelengths of laser light with which light condensing control is performed is plural, has been mainly described, however, in the case where light condensing irradiation of laser light at a single wavelength is performed, it is also possible to preferably apply a light modulation control method according to the above-described configuration. In this case, for example, in the above-described ORA method, a parameter Wₓ for adjusting a light quantity ratio among plural wavelengths is not updated as Wₓ=1. In the case of light condensing irradiation of laser light at a single wavelength, for example, it is also possible to provide a light condensing pattern different for each light condensing point at the same wavelength. Further, with respect to the number of laser light sources, for example, specifically, various specific configurations such as a configuration in which laser light at plural wavelengths is supplied from a single laser light source may be used.

Further, with respect to the design of a modulation pattern (CGH) to be presented in a spatial light modulator as well, specifically, various methods other than the examples described above may be used. In general, it suffices that, in the design of a modulation pattern, by focusing on an effect on a light condensing state of laser light on a light condensing point by changing a phase value of one pixel in a modulation pattern, the phase value is changed such that its light condensing state is brought closer to a desired state, and such phase value changing operations are performed for all the pixels in the modulation pattern, thereby designing a modulation pattern, and, when evaluating the light condensing state on the light condensing point, a propagation function to which a phase pattern opposite to a light condensing control pattern is added may be used for propagation of light at a wavelength λₓ from a pixel j in the modulation pattern of the spatial light modulator to the light condensing point s.

Further, in derivation of the complex amplitude U_{s,x} a propagation function

φ_{js,x}′=φ_{js,x}−φ_{js-pat,x}

is substituted for the formula,

$$\begin{matrix}{U}_{s , x} = {Σ}_{j} {A}_{j - in , x} exp \{ i ( {φ}_{js , x} - {φ}_{js - pat , x} + {φ}_{j , x} + {φ}_{j - in , x} ) \} \\ = {Σ}_{j} {A}_{j - in , x} exp \{ i ( {φ}_{js , x} + {φ}_{j , x} + {φ}_{j - in , x} - {φ}_{js - pat , x} ) \}\end{matrix}$$

is derived. As is clear from this formula, the same result is obtained by adding (−φ_{js-pat,x}) to an incident phase φ_{j-in,x} for the purpose of calculation. Such a method is equivalent to a method of adding (−φ_{js,pat,x}) to the propagation function φ_{js,x}, and accordingly, the present invention also includes such a configuration.

The light modulation control method according to the above-described embodiment (1) which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the method includes (2) an irradiation condition acquiring step of acquiring the number of wavelengths xₜ (xₜ is an integer of 1 or more) of the laser light to be input to the spatial light modulator, xₜ wavelengths λₓ (x=1, . . . , and xₜ), and incident conditions of the laser light at each wavelength λₓ to the spatial light modulator, as irradiation conditions of the laser light, (3) a light condensing condition setting step of setting the number of the light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s (s=1, . . . , and sₜ), as light condensing conditions of the laser light, (4) a control pattern setting step of setting a light condensing control pattern for controlling a light condensing state as a phase pattern to be provided for the laser light at the wavelength λₓ for each of the sₜ light condensing points s, and (5) a modulation pattern designing step of designing the modulation pattern to be presented in the spatial light modulator in consideration of the light condensing control pattern set in the control pattern setting step, and in the method, (6) the modulation pattern designing step assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and when evaluating the light condensing state on the light condensing point, a propagation function φ_{js,x}′

φ_{js,x}′=φ_{js,x}−φ_{js-pat,x}

that is, a phase pattern opposite to the light condensing control pattern φ_{js-pat,x} which is set in the control pattern setting step is added to a wave propagation function φ_{js,x} is used, for propagation of light at a wavelength λₓ from a pixel j in the modulation pattern of the spatial light modulator to the light condensing point s.

Further, the light modulation control program according to the present embodiment (1) which is for causing a computer to execute light modulation control that controls light condensing irradiation of the laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the program causes the computer to execute (2) irradiation condition acquiring processing of acquiring the number of wavelengths xₜ (xₜ is an integer of 1 or more) of the laser light to be input to the spatial light modulator, xₜ wavelengths λₓ (x=1, . . . , and xₜ), and incident conditions of the laser light at each wavelength λₓ to the spatial light modulator, as irradiation conditions of the laser light, (3) light condensing condition setting processing of setting the number of light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s (s=1, . . . , and sᵣ), as light condensing conditions of the laser light, (4) control pattern setting processing of setting a light condensing control pattern for controlling a light condensing state as a phase pattern to be provided for the laser light at the wavelength λₓ for each of the sₜ light condensing points s, and (5) modulation pattern designing processing of designing the modulation pattern to be presented in the spatial light modulator in consideration of the light condensing control pattern set in the control pattern setting processing, and in the program, (6) the modulation pattern designing processing assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and when evaluating the light condensing state on the light condensing point, a propagation function φ_{js,x}′

φ_{js,x}′=φ_{js,x}−φ_{js-pat,x}

that is, a phase pattern opposite to the light condensing control pattern φ_{js-pat,x} which is set in the control pattern setting processing is added to a wave propagation function φ_{js,x} is used, for propagation of light at a wavelength λₓ from a pixel j in the modulation pattern of the spatial light modulator to the light condensing point s.

Further, the light modulation control device according to the present embodiment (1) which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the device includes (2) irradiation condition acquiring means for acquiring the number of wavelengths xₜ (xₜ is an integer of 1 or more) of the laser light to be input to the spatial light modulator, xₜ wavelengths λₓ (x=1, . . . , and xₜ), and incident conditions of the laser light at each wavelength λₓ to the spatial light modulator, as irradiation conditions of the laser light, (3) light condensing condition setting means for setting the number of light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s (s=1, . . . , and sₜ), as light condensing conditions of the laser light, (4) control pattern setting means for setting a light condensing control pattern for controlling a light condensing state as a phase pattern to be provided for the laser light at the wavelength λₓ for each of the sₜ light condensing points s, and (5) modulation pattern designing means for designing the modulation pattern to be presented in the spatial light modulator in consideration of the light condensing control pattern set in the control pattern setting means, and in the device, (6) the modulation pattern designing means assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and when evaluating the light condensing state on the light condensing point, a propagation function φ_{js,x}′

φ_{js,x}′=φ_{js,x}−φ_{js-pat,x}

that is, a phase pattern opposite to the light condensing control pattern φ_{js-pat,x} which is set in the control pattern setting means is added to a wave propagation function φ_{js,x}, is used, for propagation of light at a wavelength λₓ from a pixel j in the modulation pattern of the spatial light modulator to the light condensing point s.

Here, in the light modulation control method, the control program, and the control device described above, a configuration in which the number of wavelengths xₜ of the laser light is set to a plural number may be used for acquisition of irradiation conditions. As described above, a method of designing a modulation pattern by use of a propagation function to which a phase pattern opposite to a light condensing control pattern is added, is particularly effective for the control of the light condensing irradiation conditions of laser light containing the plural wavelength components in this way.

Further, in the case where light condensing irradiation of laser light containing plural wavelength components is performed as described above, the light modulation control method, the control program, and the control device may use a configuration in which the modulation pattern is designed in consideration of wavelength dispersion of a refractive index in the spatial light modulator in the design of a modulation pattern. Thereby, it is possible to more accurately control the light condensing irradiation conditions of the laser light at the wavelength λₓ on each light condensing point s for the respective wavelengths λₓ different from each other.

Further, the light modulation control method, the control program, and the control device may use a configuration in which, in the design of a modulation pattern, given that an incident amplitude of the laser light at the wavelength λₓ to the pixel j in the spatial light modulator is A_{j-in,x}, its phase is φ_{j-in,x}, and a phase value for the laser light at the wavelength λₓ of the pixel j is φ_{j,x} a complex amplitude indicating a light condensing state of the laser light at the wavelength λₓ on the light condensing point s is determined by the following formula.

$$\begin{matrix}{U}_{s , x} = {A}_{s , x} exp ( i {φ}_{s , x} ) \\ = {Σ}_{j} {A}_{j - in , x} exp ( {iφ}_{js , x}^{′} ) \times exp ( i ( {φ}_{j , x} + {φ}_{j - in , x} ) )\end{matrix}$$

Thereby, it is possible to preferably evaluate a light condensing state of the laser light on the light condensing point s.

As a specific configuration in the design of a modulation pattern, a configuration in which a phase value is changed according to a value analytically determined based on a phase φ_{s,x} of a complex amplitude indicating the light condensing state of the laser light at the wavelength λₓ on the light condensing point s, the propagation function φ_{js,x}′, a phase value φ_{j,x} of the pixel j before change, and an incident phase φ_{j-in,x} of the laser light may be used for changing the phase value of the pixel j in the modulation pattern. As a design method of analytically updating a phase value in this way, there is, for example, an ORA (Optimal Rotation Angle) method.

Or, with respect to the design of a modulation pattern, a configuration in which a phase value is changed according to a value determined by searching by use of any method of a hill-climbing method, a simulated annealing method, and a genetic algorithm may be used for changing the phase value of the pixel j in the modulation pattern.

Further, the light modulation control device may also be configured to include light modulator drive control means for drive-controlling the spatial light modulator, to present the modulation pattern designed by the modulation pattern designing means to the spatial light modulator. Further, such light modulator drive control means may also be configured to be provided as a separate device from the light modulation control device which performs the design of a modulation pattern.

The laser light irradiation device according to the present embodiment includes (a) a laser light source which supplies laser light with xₜ (xₜ is an integer of 1 or more) wavelengths λₓ, (b) a phase-modulation type spatial light modulator which inputs the laser light thereto, to modulate a phase of the laser light, and which outputs the phase-modulated laser light, and (c) the light modulation control device having the above-described configuration, which controls light condensing irradiation of the laser light at each wavelength λₓ onto set sₜ (sₜ is an integer of 1 or more) light condensing points s by a modulation pattern to be presented in the spatial light modulator.

In accordance with such a configuration, the light condensing control pattern set for each light condensing point s and wavelength λₓ is reliably reflected into a modulation pattern to be finally obtained by the light modulation control device, which makes it possible to preferably achieve light condensing control of the laser light at a sufficient degree of freedom, and it is possible to preferably achieve light condensing irradiation of the laser light on the light condensing point s set on an irradiation object, and operations such as processing, observations, and the like of the object thereby. Such a laser light irradiation device may be used as, for example, a laser processing device, a laser microscope, or the like. In addition, as a spatial light modulator, it is preferable to use a spatial light modulator having a plurality of two-dimensionally arrayed pixels, which is configured to modulate a phase of the laser light for each of the plurality of pixels.

### INDUSTRIAL APPLICABILITY

The present invention is applicable as a light modulation control method, a control program, a control device, and a laser light irradiation device by which it is possible to preferably achieve light condensing control of laser light at a sufficient degree of freedom.

### REFERENCE SIGNS LIST

1A, 1B—laser light irradiation device, 10—laser light source unit, 11—laser light source, 12—laser light source, 13, 14—beam expander, 15—dichroic mirror, 16—mirror, 18—prism, 20—spatial light modulator, 21—mirror, 22, 23—4f optical system lens, 25—objective lens, 28—light modulator driving device, 40—movable stage, 42—irradiation object, 45—detection unit, 46—lens, 47—dichroic mirror,

51, 52—spatial filter, 53, 54—collimator lens, 55—mirror, 56—dichroic mirror, 57—half mirror, 58—lens, 60—camera,

30—light modulation control device, 31—irradiation condition acquiring unit, 32—light condensing condition setting unit, 33—light condensing control pattern setting unit, 34—modulation pattern designing unit, 35—light modulator drive control unit, 37—input device, 38—display device.

1. A light modulation control method which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the method comprising:
an irradiation condition acquiring step of acquiring the number of wavelengths xₜ (xₜ is an integer of 1 or more) of the laser light to be input to the spatial light modulator, xₜ wavelengths λₓ, and incident conditions of the laser light at each wavelength to the spatial light modulator, as irradiation conditions of the laser light;
a light condensing condition setting step of setting the number of the light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s, as light condensing conditions of the laser light;
a control pattern setting step of setting a light condensing control pattern for controlling a light condensing state as a phase pattern to be provided for the laser light at the wavelength λₓ for each of the sₜ light condensing points s; and
a modulation pattern designing step of designing the modulation pattern to be presented in the spatial light modulator in consideration of the light condensing control pattern set in the control pattern setting step, the method wherein
the modulation pattern designing step assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and
when evaluating the light condensing state on the light condensing point, a propagation function φ_{js,x}′
φ_{js,x}′=φ_{js,x}−φ_{js-pat,x}
that is, a phase pattern opposite to the light condensing control pattern φ_{js-pat,x} which is set in the control pattern setting step is added to a wave propagation function φ_{js,x} is used, for propagation of light at a wavelength λₓ from a pixel j in the modulation pattern of the spatial light modulator to the light condensing point s.

2. The light modulation control method according to claim 1, wherein the irradiation condition acquiring step sets the number of wavelengths xₜ of the laser light to a plural number.

3. The light modulation control method according to claim 2, wherein the modulation pattern designing step designs the modulation pattern in consideration of wavelength dispersion of a refractive index in the spatial light modulator.

4. The light modulation control method according to any claim 1, wherein the modulation pattern designing step determines a complex amplitude indicating the light condensing state of the laser light at the wavelength λₓ on the light condensing point s, given that an incident amplitude of the laser light at the wavelength λₓ to the pixel j in the spatial light modulator is A_{j-in,x} its phase is φ_{j-in,x}, and a phase value for the laser light at the wavelength λₓ of the pixel j is φ_{j,x}, by the following formula.
$$\begin{matrix}{U}_{s , x} = {A}_{s , x} exp ( i {φ}_{s , x} ) \\ = {Σ}_{j} {A}_{j - in , x} exp ( {iφ}_{js , x}^{′} ) \times exp ( i ( {φ}_{j , x} + {φ}_{j - in , x} ) )\end{matrix}$$

5. The light modulation control method according to claim 1, wherein the modulation pattern designing step changes a phase value according to a value analytically determined based on a phase φ_{s,x}, of a complex amplitude indicating the light condensing state of the laser light at the wavelength λₓ on the light condensing point s, the propagation function φ_{js,x}′, a phase value φ_{j,x} of the pixel j before change, and an incident phase φ_{j-in,x} of the laser light in changing of the phase value of the pixel j in the modulation pattern.

6. The light modulation control method according to claim 1, wherein the modulation pattern designing step changes a phase value according to a value determined by searching by use of any method of a hill-climbing method, a simulated annealing method, and a genetic algorithm in changing of the phase value of the pixel j in the modulation pattern.

7. A light modulation control program which is for causing a computer to execute light modulation control which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the program causes the computer to execute:
irradiation condition acquiring processing of acquiring the number of wavelengths xₜ (xₜ is an integer of 1 or more) of the laser light to be input to the spatial light modulator, xₜ wavelengths λₓ, and incident conditions of the laser light at each wavelength to the spatial light modulator, as irradiation conditions of the laser light;
light condensing condition setting processing of setting the number of light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s, as light condensing conditions of the laser light;
control pattern setting processing of setting a light condensing control pattern for controlling a light condensing state as a phase pattern to be provided for the laser light at the wavelength λₓ for each of the sₜ light condensing points s; and
modulation pattern designing processing of designing the modulation pattern to be presented in the spatial light modulator in consideration of the light condensing control pattern set in the control pattern setting processing, the program wherein
the modulation pattern designing processing assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and
when evaluating the light condensing state on the light condensing point, a propagation function φ_{js,x}′
φ_{js,x}′=φ_{js,x}−φ_{js-pat,x}
that is, a phase pattern opposite to the light condensing control pattern φ_{js-pat,x} which is set in the control pattern setting processing is added to a wave propagation function φ_{js,x} is used, for propagation of light at a wavelength λₓ from a pixel j in the modulation pattern of the spatial light modulator to the light condensing point s.

8. The light modulation control program according to claim 7, wherein the irradiation condition acquiring processing sets the number of wavelengths xₜ of the laser light to a plural number.

9. The light modulation control program according to claim 8, wherein the modulation pattern designing processing designs the modulation pattern in consideration of wavelength dispersion of a refractive index in the spatial light modulator.

10. The light modulation control program according to claim 7, wherein the modulation pattern designing processing determines a complex amplitude indicating the light condensing state of the laser light at the wavelength λₓ on the light condensing point s, given that an incident amplitude of the laser light at the wavelength λₓ to the pixel j in the spatial light modulator is A_{j-in,x}, its phase is φ_{j-in,x}, and a phase value for the laser light at the wavelength λₓ of the pixel j is φ_{j,x}, by the following formula.
$$\begin{matrix}{U}_{s , x} = {A}_{s , x} exp ( i {φ}_{s , x} ) \\ = {Σ}_{j} {A}_{j - in , x} exp ( {iφ}_{js , x}^{′} ) \times exp ( i ( {φ}_{j , x} + {φ}_{j - in , x} ) )\end{matrix}$$

11. The light modulation control program according to claim 7, wherein the modulation pattern designing processing changes a phase value according to a value analytically determined based on a phase φ_{s,x} of a complex amplitude indicating the light condensing state of the laser light at the wavelength λₓ on the light condensing point s, the propagation function φ_{js,x}′, a phase value φ_{j,x} of the pixel j before change, and an incident phase φ_{j-in,x} of the laser light in changing of the phase value of the pixel j in the modulation pattern.

12. The light modulation control program according to claim 7, wherein the modulation pattern designing processing changes a phase value according to a value determined by searching by use of any method of a hill-climbing method, a simulated annealing method, and a genetic algorithm in changing of the phase value of the pixel j in the modulation pattern.

13. A light modulation control device which controls light condensing irradiation of laser light onto a set light condensing point by a modulation pattern to be presented in a spatial light modulator by use of the phase-modulation type spatial light modulator that inputs the laser light thereto, to modulate a phase of the laser light, and that outputs the phase-modulated laser light, the device comprising:
irradiation condition acquiring means acquiring the number of wavelengths xₜ (xₜ is an integer of 1 or more) of the laser light to be input to the spatial light modulator, xₜ wavelengths λₓ, and incident conditions of the laser light at each wavelength to the spatial light modulator, as irradiation conditions of the laser light;
light condensing condition setting means setting the number of light condensing points sₜ (sₜ is an integer of 1 or more) on which light condensing irradiation of the laser light from the spatial light modulator is performed, and a light condensing position, a wavelength λₓ of the laser light to be condensed, and a light condensing intensity for each of the sₜ light condensing points s, as light condensing conditions of the laser light;
control pattern setting means setting a light condensing control pattern for controlling a light condensing state as a phase pattern to be provided for the laser light at the wavelength λₓ for each of the sₜ light condensing points s; and
modulation pattern designing means designing the modulation pattern to be presented in the spatial light modulator in consideration of the light condensing control pattern set in the control pattern setting means, the device wherein
the modulation pattern designing means assumes a plurality of two-dimensionally arrayed pixels in the spatial light modulator, changes a phase value so as to bring a light condensing state closer to a desired state by focusing on an effect on the light condensing state of the laser light on the light condensing point by changing the phase value of one pixel in the modulation pattern to be presented in the plurality of pixels, and performs such phase value changing operations for all the pixels in the modulation pattern, thereby designing the modulation pattern, and
when evaluating the light condensing state on the light condensing point, a propagation function φ_{js,x}′
φ_{js,x}′=φ_{js,x}−φ_{js-pat,x}
that is, a phase pattern opposite to the light condensing control pattern φ_{js-pat,x} which is set in the control pattern setting means is added to a wave propagation function φ_{js,x} is used, for propagation of light at a wavelength λₓ from a pixel j in the modulation pattern of the spatial light modulator to the light condensing point s.

14. The light modulation control device according to claim 13, wherein the irradiation condition acquiring means sets the number of wavelengths xₜ of the laser light to a plural number.

15. The light modulation control device according to claim 14, wherein the modulation pattern designing means designs the modulation pattern in consideration of wavelength dispersion of a refractive index in the spatial light modulator.

16. The light modulation control device according to claim 13, wherein the modulation pattern designing means determines a complex amplitude indicating the light condensing state of the laser light at the wavelength λₓ on the light condensing point s, given that an incident amplitude of the laser light at the wavelength λₓ to the pixel j in the spatial light modulator is A_{j-in,x}, its phase is φ_{j-in,x}, and a phase value for the laser light at the wavelength λₓ of the pixel j is φ_{j,x}, by the following formula.
$$\begin{matrix}{U}_{s , x} = {A}_{s , x} exp ( i {φ}_{s , x} ) \\ = {Σ}_{j} {A}_{j - in , x} exp ( {iφ}_{js , x}^{′} ) \times exp ( i ( {φ}_{j , x} + {φ}_{j - in , x} ) )\end{matrix}$$

17. The light modulation control device according to claim 13, wherein the modulation pattern designing means changes a phase value according to a value analytically determined based on a phase φ_{s,x} of a complex amplitude indicating the light condensing state of the laser light at the wavelength λₓ on the light condensing point s, the propagation function φ_{js,x}′, a phase value φ_{j,x} of the pixel j before change, and an incident phase φ_{j-in,x} of the laser light in changing of the phase value of the pixel j in the modulation pattern.

18. The light modulation control device according to claim 13, wherein the modulation pattern designing means changes a phase value according to a value determined by searching by use of any method of a hill-climbing method, a simulated annealing method, and a genetic algorithm in changing of the phase value of the pixel j in the modulation pattern.

19. The light modulation control device according to claim 13, further comprising light modulator drive control means for drive-controlling the spatial light modulator, to present the modulation pattern designed by the modulation pattern designing means in the spatial light modulator.

20. A laser light irradiation device comprising:
a laser light source which supplies laser light with xₜ (xₜ is an integer of 1 or more) wavelengths λₓ;
a phase-modulation type spatial light modulator which inputs the laser light thereto, to modulate a phase of the laser light, and which outputs the phase-modulated laser light; and
the light modulation control device according to claim 13, which controls light condensing irradiation of the laser light at each wavelength λₓ onto set sₜ (sₜ is an integer of 1 or more) light condensing points s by a modulation pattern to be presented in the spatial light modulator.
